(19) United States
(12) Patent Application Publication
(10) Pub. No.: US 2025/0236114 A1
(43) Pub. Date: Jul. 24, 2025

(54) PRINTING APPARATUS AND PRINTING METHOD

(71) Applicants: Daiki ETO, Kanagawa (JP); Masanori HIRANO, Kanagawa (JP)

(72) Inventors: Daiki ETO, Kanagawa (JP); Masanori HIRANO, Kanagawa (JP)

(21) Appl. No.: 19/017,856

(22) Filed: Jan. 13, 2025

(30) Foreign Application Priority Data
Jan. 23, 2024 (JP) 2024-008270

(51) Int. Cl. B41J 2/21; B41J 2/315; B41J 3/407

(52) U.S. Cl. CPC B41J 2/2117; B41J 2/315; B41J 3/4078

(57) ABSTRACT

A printing apparatus includes a pretreatment-liquid applier, a white-ink applier, a color-ink applier, a colorless-liquid applier, and circuitry. The pretreatment-liquid applier applies a pretreatment liquid to a pretreatment area in a permeable print target. The white-ink applier applies a white ink including an organic solvent to an image forming area in the pretreatment area to form a base layer. The organic solvent seeps into a seepage area around the image forming area. The color-ink applier applies a color ink to the image forming area to form a color image. The colorless-liquid applier applies a colorless liquid including water to a colorless-liquid area including at least a part of the seepage area. The circuitry changes the colorless-liquid area according to a timing of applying the colorless liquid to the colorless-liquid area in a process of applying the pretreatment liquid, the white ink, and the color ink to the permeable print target.

### CROSS-REFERENCE TO RELATED APPLICATION

This patent application is based on and claims priority pursuant to 35 U.S.C. § 119 (a) to Japanese Patent Application No. 2024-008270, filed on Jan. 23, 2024, in the Japan Patent Office, the entire disclosure of which is hereby incorporated by reference herein.

### BACKGROUND

### Technical Field

The present disclosure relates to a printing apparatus and a printing method.

### Related Art

Direct-to-garment (DTG) printing is known that directly discharges ink onto a cloth using an inkjet technology to perform printing. In the DTG printing, to firmly fix a colorant to the cloth, which is a print target onto which printing is performed, a pretreatment liquid is applied to the cloth before the printing. By applying the pretreatment liquid to the cloth, an ink including a white pigment, which is difficult to be fixed to fibers of the cloth, and a polyester fiber, to which the ink is difficult to be fixed, can be used.

### SUMMARY

The present disclosure described herein provides an improved printing apparatus including a pretreatment-liquid applier, a white-ink applier, a color-ink applier, a colorless-liquid applier, and circuitry. The pretreatment-liquid applier applies a pretreatment liquid to a pretreatment area in a permeable print target to form a pretreatment layer. The white-ink applier applies a white ink including an organic solvent to an image forming area in the pretreatment area to form a base layer of the white ink on the pretreatment layer. The organic solvent seeps into a seepage area around the image forming area to form the seepage area. The color-ink applier applies a color ink including an organic solvent to the image forming area to form a color image on the base layer of the white ink. The colorless-liquid applier applies a colorless liquid including water to a colorless-liquid area including at least a part of the seepage area. The circuitry changes the colorless-liquid area according to a timing of applying the colorless liquid to the colorless-liquid area in a process of applying the pretreatment liquid, the white ink, and the color ink to the permeable print target.

Further, the present disclosure described herein provides an improved printing method. The printing method includes applying a pretreatment liquid to a pretreatment area in a permeable print target to form a pretreatment layer and applying a white ink including an organic solvent to an image forming area in the pretreatment area to form a base layer of the white ink on the pretreatment layer. The organic solvent seeps into a seepage area around the image forming area to form the seepage area. The printing method further includes applying a color ink including an organic solvent to the image forming area to form a color image on the base layer of the white ink, applying a colorless liquid including water to a colorless-liquid area including at least a part of the seepage area, and changing the colorless-liquid area according to a timing of applying the colorless liquid to the colorless-liquid area in a process of applying the pretreatment liquid, the white ink, and the color ink to the permeable print target.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram of a printing apparatus according to an embodiment of the present disclosure;

FIGS. 2A, 2B, 2C, and 2D are schematic diagrams each illustrating a configuration of a discharge head of various types of a printing apparatus incorporating a pretreatment-liquid discharge head as a pretreatment-liquid applier according to comparative examples;

FIGS. 3A and 3B are flowcharts for explaining that a heating step can be removed by incorporating the pretreatment-liquid applier in a printing apparatus;

FIGS. 4A and 4B are diagrams each illustrating a relation between an area to which a pretreatment liquid is applied and an area on which a print image is formed;

FIG. 5 is a diagram illustrating a trace of ink seepage formed when a white ink is applied;

FIGS. 6A and 6B are diagrams each illustrating a process in which the trace of ink seepage is formed as viewed in a cross section of a color cloth;

FIGS. 7A and 7B are flowcharts illustrating a printing method according to a comparative example and a printing method according to an embodiment of the present disclosure for comparing the number of steps in a method of removing the trace of ink seepage;

FIGS. 8A to 8D are diagrams illustrating the progress of the state of a surface of a color cloth in a printing method according to an embodiment of the present disclosure (example 1);

FIGS. 9A to 9C are diagrams illustrating the progress of the state of a surface of a color cloth in a printing method according to an embodiment of the present disclosure (example 2);

FIGS. 10A to 10C are diagrams illustrating the progress of the state of a surface of a color cloth in a printing method according to an embodiment of the present disclosure (example 3);

FIGS. 11A to 11C are diagrams illustrating the progress of the state of a surface of a color cloth in a printing method according to an embodiment of the present disclosure (example 4);

FIGS. 12A to 12C are diagrams illustrating the progress of the state of a surface of a color cloth in a printing method according to an embodiment of the present disclosure (example 5);

FIGS. 13A to 13C are diagrams illustrating the progress of the state of a surface of a color cloth in a printing method according to an embodiment of the present disclosure (example 6);

FIGS. 14A to 14C are diagrams illustrating the progress of the state of a surface of a color cloth in a printing method according to an embodiment of the present disclosure (example 7);

FIG. 15 is a diagram illustrating an area to which a colorless liquid is applied;

FIG. 16 is a conceptual diagram illustrating the dilution of a pretreatment liquid by the discharge of a colorless liquid;

FIG. 17 is a table including cross-sectional views of a cloth when the pretreatment liquid is applied to the cloth having low absorbency;

FIG. 18 is a table including cross-sectional views of a cloth when the pretreatment liquid is applied to the cloth having high absorbency;

FIGS. 19A and 19B are perspective views of a printing apparatus using an inkjet system, according to an embodiment of the present disclosure;

FIGS. 20A and 20B are top views of a printing apparatus using an inkjet system, according to an embodiment of the present disclosure;

FIG. 21 is a diagram illustrating a configuration of a carriage of a printing apparatus using an inkjet system, according to an embodiment of the present disclosure (example 1);

FIG. 22 is a diagram illustrating a configuration of a carriage of a printing apparatus using an inkjet system, according to an embodiment of the present disclosure (example 2);

FIG. 23 is a diagram illustrating a configuration of a carriage of a printing apparatus using an inkjet system, according to an embodiment of the present disclosure (example 3);

FIG. 24 is a diagram illustrating a configuration of a carriage of a printing apparatus using an inkjet system, according to an embodiment of the present disclosure (example 4);

FIG. 25 is a diagram illustrating a configuration of a carriage of a printing apparatus using an inkjet system, according to an embodiment of the present disclosure (example 5);

FIG. 26 is a diagram illustrating a configuration of a carriage of a printing apparatus using an inkjet system, according to an embodiment of the present disclosure (example 6);

FIG. 27 is a diagram illustrating a configuration of a carriage of a printing apparatus using an inkjet system, according to an embodiment of the present disclosure (example 7); and

FIG. 28 is a block diagram of a controller of a printing apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A printing apparatus according to an embodiment of the present disclosure includes a pretreatment-liquid applier that applies a pretreatment liquid to a predetermined area on a permeable print target onto which printing is performed, a white-ink applier that applies a white ink to an area to which the pretreatment liquid is applied to form a base of the white ink, a color-ink applier that applies a color ink to a predetermined area on the base of the white ink to form a color image, and a colorless-liquid applier that applies a colorless liquid including water to a predetermined area including at least a part of a trace of ink seepage area around an image forming area, and adjusts (changes) an area to which the colorless liquid is applied according to a timing of applying the colorless liquid. The printing apparatus may further include a heater that performs heating after an image is formed if desired, and may further include other units if desired.

The area, such as the predetermined area on the permeable print target onto which printing is performed, the area to which the pretreatment liquid is applied, the predetermined area on the base of the white ink, and the predetermined area including at least a part of a trace of ink seepage area around an image forming area, includes an actually formed area, an area scheduled to be formed, an area set (stored) in advance in a storage device of a computer (control device), and a combination thereof.

A printing method according to an embodiment of the present disclosure includes a pretreatment-liquid application step to discharge a pretreatment liquid to a predetermined area on a permeable print target onto which printing is performed, a white-ink application step to apply a white ink to an area to which the pretreatment liquid is applied to form a base of the white ink, a color-ink application step to apply a color ink to a predetermined area on the base of the white ink to form a color image, and a colorless-liquid application step to apply a colorless liquid including water to a predetermined area including a trace of ink seepage area around an image forming area, and adjusts (changes) an area to which the colorless liquid is applied according to a timing of applying the colorless liquid. The printing method may further include a heating step to perform heating after an image is formed if desired, and may further include other steps if desired. The other steps may be performed at any desired timing as long as the gist of the embodiments of the present disclosure is not impaired.

The printing method according to an embodiment of the present disclosure can be suitably performed by the printing apparatus according to an embodiment of the present disclosure, the pretreatment-liquid application step can be performed by the pretreatment-liquid applier, the white-ink application step can be performed by the white-ink applier, the color-ink application step can be performed by the color-ink applier, the colorless-liquid application step can be performed by the colorless-liquid applier, and the heating step can be performed by the heater.

The “permeable print target onto which printing is performed” in embodiments of the present disclosure is an object into which a pretreatment liquid and ink applied to the surface of the object permeate. Examples of such an object include a cloth. The cloth is a material obtained by forming fibers into, for example, a woven fabric, a knitted fabric, or a nonwoven fabric. The thickness of the fibers and the size of the mesh of the fibers are not limited.

Examples of the fiber are not limited and may be appropriately selected depending on the intended purpose. Examples of the fiber may include natural fibers, chemical fibers, biodegradable fibers, and mixed fibers thereof.

Examples of the natural fibers include fibers made of cotton, hemp, wool, silk, and mixed fibers thereof. Examples of the chemical fibers include regenerated fibers, synthetic fibers, semi-synthetic fibers, and mixed fibers thereof. Examples of the regenerated fibers include fibers made of viscose, lyocell, polynosic, rayon, cupra, and mixed fibers thereof. Examples of the synthetic fibers include fibers made of polypropylene, polyester, acetate, triacetate, polyurethane, polyamide, polyimide, acrylic, polyvinyl alcohol, polyvinyl chloride, nylon, NOMEX (registered trademark, manufactured by Du Pont), KEVLAR (registered trademark, manufactured by Du Pont), and mixed fibers thereof. Examples of the semi-synthetic fibers include fibers made of acetate, diacetate, triacetate, and mixed fibers thereof. Examples of the biodegradable fibers include fibers made of polylactic acid.

Embodiments of the present disclosure can prevent a trace of ink seepage that is caused by the organic solvent contained in white ink used in a large amount as the base. Preferably, the permeable print target onto which printing is performed is a color cloth. Embodiments of the present disclosure are described below using an example in which the permeable print target onto which printing is performed is a color cloth.

In embodiments of the present disclosure, the “color cloth” is a cloth other than a white cloth, and a black cloth is also included in the color cloth. The pretreatment liquid and the color ink may seep onto the surface of a white cloth. However, typically, such a trace caused by the seepage on the white cloth is not conspicuous in many cases. However, when the trace is conspicuous even on a white cloth, the white cloth may be included in the color cloth.

A printing apparatus according to an embodiment of the present disclosure is described below in detail.

### Pretreatment-Liquid Applier

The pretreatment-liquid applier performs the pretreatment-liquid application step to apply the pretreatment liquid to a predetermined area including the image forming area on the color cloth to form a pretreatment layer. The pretreatment liquid applied to the color cloth allows ink to be firmly fixed to the color cloth. Accordingly, the base can be formed using a large amount of white ink.

The “image forming area” indicates an area occupied by an image formed with the white ink and the color ink, including the base of the white ink formed by the white-ink applier to be described later, which is the same area as the area to which the white ink is applied. However, when an image is formed with only the white ink, the “image forming area” may be formed with only the white ink, and if there is an area in which an image is formed with the same color as the color cloth, the white ink and the color ink may not be applied the area, and this area may also be referred to as the “image forming area.”

The pretreatment liquid according to embodiments of the present disclosure includes a coagulant for fixing the ink to the color cloth. The coagulant is a component that causes the white ink or the color ink to coagulate or thicken when the pretreatment liquid contacts the white ink or the color ink. Specific examples of the coagulant include a component that coagulates water-dispersible particles such as a colorant or resin contained in the white ink or the color ink. Applying the pretreatment liquid including such a coagulant onto the color cloth allows the white ink that has contacted the pretreatment liquid to be firmly fixed onto the color cloth. Accordingly, a base of the white ink can be formed.

The pretreatment-liquid applier is not limited and can be appropriately selected depending on the intended purpose. Examples of the pretreatment-liquid applier include an inkjet head, a sprayer, a hand spray, a coating roller, and a brush, and the inkjet head is preferable from the viewpoint of easily incorporating the white-ink applier, the color-ink applier, and the colorless-liquid applier, which will be described later, together with the pretreatment-liquid applier in the same apparatus.

When the inkjet head is used as the pretreatment-liquid applier, the pretreatment-liquid applier, and the white-ink applier, the color-ink applier, and the colorless-liquid applier to be described later can be incorporated in the same apparatus, and thus the apparatus can be downsized. By incorporating and controlling the pretreatment-liquid applier together with the white-ink applier, the color-ink applier, and the colorless-liquid applier to be described later in the same apparatus, the pretreatment liquid can be accurately applied in accordance with the area to which the ink is applied, and a usage amount of the pretreatment liquid can be reduced.

The pretreatment liquid may be applied only to the image forming area. Alternatively, the pretreatment liquid may be applied not only to the image forming area but also to an area around the image forming area. In embodiments of the present disclosure, the area to which the pretreatment liquid is applied around the image forming area is referred to as an “extended area” out of the image forming area. An entire area to which the pretreatment liquid is applied including the image forming area and the extended area is referred to as a “pretreatment-liquid application area” or simply as a “pretreatment area.”

When the pretreatment liquid is applied only to the image forming area, the usage amount of the pretreatment liquid can be reduced. When the pretreatment liquid is applied not only to the image forming area but also to the extended area, an insufficient coloring of the ink due to a landing positional deviation between the pretreatment liquid and the ink can be prevented.

### White-Ink Applier and Color-Ink Applier

The white-ink applier performs the white-ink application step to apply the white ink to a predetermined area (i.e., the image forming area) on the area to which the pretreatment liquid is applied to form the base (base layer) of the white ink on the pretreatment layer. The color-ink applier performs the color-ink application step to apply the color ink to a predetermined area on the base of the white ink to form a color image on the base layer. Since the pretreatment liquid is applied by the pretreatment-liquid application step before the white-ink application step and the color-ink application step, the white ink and the color ink are reliably fixed onto the color cloth.

Typically, an inkjet head is used as the white-ink applier and the color-ink applier.

The role of the white ink as a base is as follows.

First role: The white ink as the base cancels (conceals) the color of the color cloth and the texture of the surface of the color cloth to enhance the whiteness and smoothness of the color cloth as a canvas. The white ink as the base also serves to represent the white portion of the image.

Second role: The white ink as the base serves as an intermediate layer to physically receive the color ink.

The first role of the white ink allows correct color and gradation to be produced in color ink printing. In the second role, naturally from the order of the ink application step, the white ink serves as a base as an intermediate layer. However, the white ink layer preferably penetrates deep into the fibers of the color cloth to form a strong base. Preferably, the amount of the white ink four times or greater than the amount of the color ink is applied to enhance whiteness as coloring, smoothness of a surface, and fastness of the cloth.

The white ink used in embodiments of the present disclosure is a liquid composition to be applied to a print target to form a white color image on the print target. White color is a color referred to as white in the sense of common sense, and includes colors which are colored by a small amount of colors other than white.

The color ink used in embodiments of the present disclosure is a liquid composition applied to a print target to form a color image on the print target. The color of the color ink is a color that is not included in the above-described white color, and includes, for example, black, cyan, magenta, and yellow.

The white ink and the color inks typically include an organic solvent as a wetting agent. The wetting agent is a component that moisturizes ink to prevent the ink from drying. Examples of the wetting agent include glycerin and propanediol. When an inkjet head is employed as the ink applier, the ink including a wetting agent prevents the ink from drying on a nozzle face of the inkjet head. Thus, the discharge stability of the ink is enhanced. By contrast, the wetting agent is a component having a high boiling point and remains even after the heating for fixing the ink onto the color cloth is performed, and thus is one of the causes of the trace of ink seepage formed around the image forming area.

In embodiments of the present disclosure, an area in which the trace of ink seepage is formed around the image forming area is referred to as a “trace of ink seepage area,” or simply as a “seepage area.” In other words, the organic solvent in the white ink or the color ink seeps into the seepage area, and the organic solvent that has seeped out on the surface of the color cloth is recognized as the trace of ink seepage.

### Colorless-Liquid Applier

The colorless-liquid applier performs a colorless-liquid application step to apply the colorless liquid including water to a predetermined area including the trace of ink seepage area around the image forming area. The organic solvent contained in the ink, i.e., the wetting agent has high water solubility. For this reason, the wetting agent is dissolved in the colorless liquid including water and diluted by the colorless liquid. Thus, the trace of ink seepage become thin (inconspicuous) to such an extent that the trace of ink seepage is not recognized.

The colorless-liquid application step of the present embodiment is a technology different from comparative technologies such as “humidity control” and “cleaning” as described below.

The humidity control is a process in which trace amounts of moisture are sprayed in an entire area in which printing is performed or to the entire surface of the cloth before printing. The humidity control can remove wrinkles of the cloth. In addition, the humidity control can cause the amount of moisture on the surface of the cloth to be uniform. By so doing, unevenness of ink permeation into the cloth can be eliminated. In addition, controlling the humidity in the entire area in which printing is performed can prevent the inkjet head from drying. Thus, the reliability of ink discharge can be enhanced. In comparison with the colorless-liquid application step of the present embodiment, the humidity control is a process in which trace amounts of moisture are sprayed only to adjust the humidity. For this reason, unlike the colorless-liquid application step of the present embodiment, the comparative humidity control does not remove a trace of ink seepage.

The cleaning is a process of removing dirt and impurities generated while printing is performed, and is similar to the washing. When a sublimation dye ink is used as the ink, a process in which the cloth is steamed and washed is performed to fix the ink onto the cloth. However, embodiments of the present disclosure employ the DTG printing using pigment ink. Accordingly, the process in which the cloth is steamed and washed is not necessarily performed. In comparison with the colorless-liquid application step of the present embodiment, washing the cloth after printing allows the removal of the organic solvent and the elimination of the trace of ink seepage. However, when washing and cleaning of the cloth is performed, waste liquid is generated, and drying and smoothing wrinkles are performed as subsequent processes.

The colorless-liquid applier is not limited and can be appropriately selected depending on the intended purpose. Examples of the colorless-liquid applier include an inkjet head, a sprayer (compressor), a hand spray, a steam generator, and an immersion container, and the inkjet head is preferable from the viewpoint of easily incorporating the pretreatment-liquid applier, the white-ink applier, and the color-ink applier together with the colorless-liquid applier in the same apparatus.

The colorless liquid can be appropriately selected depending on the intended purpose as long as the colorless liquid includes water and satisfies all of the following conditions 1 to 4. However, pure water is preferable.
1. The color of the colorless liquid is not changed when the colorless liquid is adhered to the image forming area or heated.
2. The boiling point of the colorless liquid is not higher than the temperature in the heating step.
3. The colorless liquid does not stain a color cloth.
4. Solid components are not precipitated out of the colorless liquid.

Examples of the colorless liquid other than pure water include an aqueous solution to which a fragrance component is added for the purpose of flavoring or deodorizing, and an aqueous solution to which a medicinal component is added for the purpose of disinfection (sterilization).

In embodiments of the present disclosure, the area to which the colorless liquid is applied (i.e., a colorless-liquid area) is adjusted according to a timing of applying the colorless liquid in a process of applying the pretreatment liquid, the white ink, and the color ink to the permeable print target (i.e., the order of processes). Examples of the timing of applying the colorless liquid include, for example, when the colorless liquid is applied after the color-ink applier applies the color ink, when the colorless liquid is applied in parallel with at least one of the application of the white ink by the white-ink applier or the application of the color ink by the color-ink applier, and when the colorless liquid is applied before the white-ink applier applies the white ink.

When the colorless-liquid applier applies the colorless liquid after the color-ink applier applies the color ink, the colorless liquid is applied to the “image forming area” and the “trace of ink seepage area.” Since the colorless-liquid application step is performed last, the white ink and the color ink have already reacted with the pretreatment liquid, and coagulate so as to be entangled with fibers of the cloth. Accordingly, an ink layer in the image forming area is not damaged unless the colorless liquid is applied with a strong force that generates a physical pressure.

As a result, the trace of ink seepage can be removed by applying the colorless liquid to the trace of ink seepage area. In addition, stickiness caused by a solvent in the image forming area can be prevented by applying the colorless liquid to the image forming area.

When the colorless-liquid applier applies the colorless liquid in parallel with at least one of the application of the white ink by the white-ink applier or the application of the color ink by the color-ink applier, the colorless liquid is not applied to the “image forming area.” Since the colorless liquid is applied before the pretreatment liquid and the ink react with each other to coagulate, if the colorless liquid is applied to the image forming area, damage such as scraping, bleeding, smearing, or melting of the image may occur.

Thus, the trace of ink seepage can be removed by applying the colorless liquid to the trace of ink seepage area. In addition, productivity can be enhanced by applying the colorless liquid in parallel with the application of the white ink or the application of the color ink.

When the colorless-liquid applier applies the colorless liquid in parallel with at least one of the application of the white ink by the white-ink applier or the application of the color ink by the color-ink applier, a gap area to which nothing but seepage of the organic solvent seeping into the seepage area is applied may be formed between the image forming area and the area to which the colorless liquid is applied (i.e., the colorless-liquid area). The gap area to which nothing is applied can reliably avoid the damage to an image due to mixing of the ink and the colorless liquid.

When the colorless-liquid applier applies the colorless liquid in parallel with at least one of the application of the white ink by the white-ink applier or the application of the color ink by the color-ink applier, a sloped area in which a smaller amount of the colorless liquid is applied to a position closer to the image forming area may be formed around the image forming area. As a result, the damage to an image due to the mixing of the ink and water can be minimized. In addition, the trace of ink seepage can be effectively removed as compared to when nothing is applied to the gap area.

When the colorless-liquid applier applies the colorless liquid before the white-ink applier applies the white ink, the colorless liquid is applied not only to the “trace of ink seepage area” but also to the “pretreatment-liquid application area.”

When undiluted pretreatment liquid does not smoothly permeate into the cloth, the colorless liquid applied to the pretreatment-liquid application area can dilute the undiluted pretreatment liquid to apply the treatment liquid onto the cloth evenly.

As a result, the trace of ink seepage can be removed by applying the colorless liquid to the trace of ink seepage area. In addition, the pretreatment liquid can be evenly applied onto the cloth, into which the pretreatment liquid does not smoothly permeate, by applying the colorless liquid to the pretreatment-liquid application area and diluting the pretreatment liquid on the cloth. Thus, image quality and washing fastness can be enhanced.

When the colorless-liquid applier applies the colorless liquid and the pretreatment-liquid applier applies the pretreatment liquid not only to the image forming area but also to the extended area before the white-ink applier applies the white ink, the colorless liquid is applied to at least an area around the extended area. Since the colorless liquid is applied before the ink is applied, if the same amount of the colorless liquid as an amount for removing the trace of ink seepage is applied to the pretreatment-liquid application area including the extended area, the pretreatment liquid is diluted, and insufficient coloring of the ink may occur. The amount of the colorless liquid for diluting the pretreatment liquid can be applied to the pretreatment-liquid application area.

As a result, the trace of ink seepage can be removed by applying the colorless liquid to at least an area around the extended area. In addition, an influence of the landing positional deviation between the pretreatment liquid and the ink can be reduced by applying the pretreatment liquid to an area wider than the image forming area.

When the colorless-liquid applier applies the colorless liquid and the pretreatment-liquid applier applies the pretreatment liquid not only to the image forming area but also to the extended area before the white-ink applier applies the white ink, the colorless liquid may be applied not only to an area around the extended area but also to the extended area. In this case, a smaller amount of the colorless liquid is applied and a larger amount of the pretreatment liquid is applied to a position closer to the image forming area in the extended area.

As compared to when the colorless liquid is applied to only an area around the extended area, the trace of ink seepage can be effectively removed by applying the colorless liquid to the extended area.

When the amount of the white ink to be applied by the white-ink applier is large, the trace of ink seepage of a solvent is remarkably formed. Accordingly, when the amount of the white ink in the image forming area is large, a large amount of the colorless liquid is applied to the trace of ink seepage area around the image forming area. On the other hand, when the amount of the white ink in the image forming area is small, a small amount of the colorless liquid is applied to the trace of ink seepage area around the image forming area. By applying an appropriate amount of the colorless liquid, the colorless liquid is efficiently used (so as not to be wastefully consumed).

Adjusting (changing) the amount of the colorless liquid to be applied is effective in printing on the color cloth. When representing the same color as the color cloth, the color of the color cloth itself may be utilized. Accordingly, a large amount of the white ink may not be applied in some cases. For example, the white ink is not applied at all to an area representing black by utilizing the color of the black cloth in the image forming area, and a large amount of the white ink is applied to an area representing white in the image forming area.

### Heater

The heater performs the heating step after the colorless-liquid applier applies the colorless liquid to evaporate and remove unnecessary moisture and fix the ink onto the color cloth. The heater may simultaneously perform heating and pressing in the heating step.

The heater is not limited and may be appropriately selected depending on the intended purpose. Examples of the heater include a heat press device that performs heating and pressing simultaneously, a hot-air drying and fixing machine that blows hot air, and a conveyor heater that conveys a medium (e.g., a cloth) under a heat source by a conveyor.

Embodiments of the present disclosure are described in more detail below with reference to the drawings.

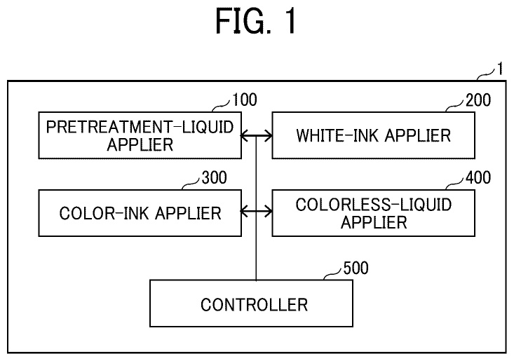

FIG. 1 is a block diagram of a printing apparatus according to an embodiment of the present disclosure.

A printing apparatus 1 includes a pretreatment-liquid applier 100, a white-ink applier 200, a color-ink applier 300, a colorless-liquid applier 400, and a controller 500. The controller 500 as circuitry controls operations of the pretreatment-liquid applier 100, the white-ink applier 200, the color-ink applier 300, and the colorless-liquid applier 400. The printing apparatus 1 will be described in detail later.

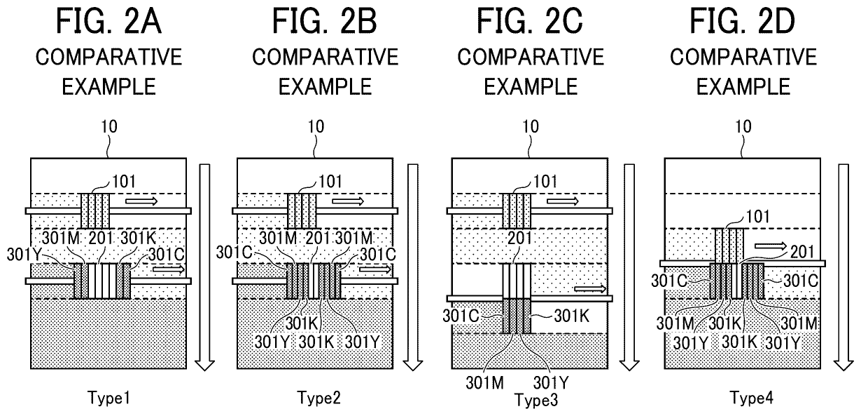

FIGS. 2A, 2B, 2C, and 2D are schematic diagrams each illustrating a configuration of a discharge head of various types of a printing apparatus incorporating a pretreatment-liquid discharge head as a pretreatment-liquid applier according to comparative examples.

Each of the printing apparatuses of types 1 to 4 illustrated in FIGS. 2A to 2D includes a pretreatment-liquid discharge head 101, a white-ink discharge head 201, and color-ink discharge heads, i.e., a yellow-ink discharge head 301Y, a magenta-ink discharge head 301M, a cyan-ink discharge head 301C, and a black-ink discharge head 301K. In FIGS. 2A to 2D, a color cloth 10 (i.e., an example of the permeable print target) is conveyed from the top to the bottom as indicated by the blank arrow. The pretreatment-liquid discharge head 101, the white-ink discharge head 201, the yellow-ink discharge head 301Y, the magenta-ink discharge head 301M, the cyan-ink discharge head 301C, and the black-ink discharge head 301K are arranged such that the pretreatment liquid is first discharged, then the white ink is discharged, and lastly the color inks of cyan, magenta, yellow, and black are discharged to perform printing.

The white-ink discharge head 201 is disposed in the center of a carriage in a direction orthogonal to the direction in which the color cloth 10 is conveyed, except for the discharge head of type 3. The carriage is a unit in which the pretreatment-liquid discharge head 101, the white-ink discharge head 201, the yellow-ink discharge head 301Y, the magenta-ink discharge head 301M, the cyan-ink discharge head 301C, and the black-ink discharge head 301K are collectively mounted. The white-ink discharge head 201 is disposed as described above such that the white ink is discharged from the white-ink discharge head 201 disposed in the center of the carriage as a starting point and then the color inks are discharged from the respective discharge heads disposed at right and left sides of the white-ink discharge head 201 when bi-directional printing, in which printing is performed by scanning the heads both left and right, is performed. In FIGS. 2A, 2B, 2C, and 2D, the yellow-ink discharge head 301Y, the magenta-ink discharge head 301M, the cyan-ink discharge head 301C, and the black-ink discharge head 301K that contain four colors of yellow, magenta, cyan, and black, respectively, are disposed. However, the order in which the yellow-ink discharge head 301Y, the magenta-ink discharge head 301M, the cyan-ink discharge head 301C, and the black-ink discharge head 301K are arranged is not limited to the example of the discharge head of types 1 to 4. Color ink heads that contain photo inks such as light cyan, light magenta, and gray, and special color inks such as red, green, blue (RGB), orange, and violet may be mounted.

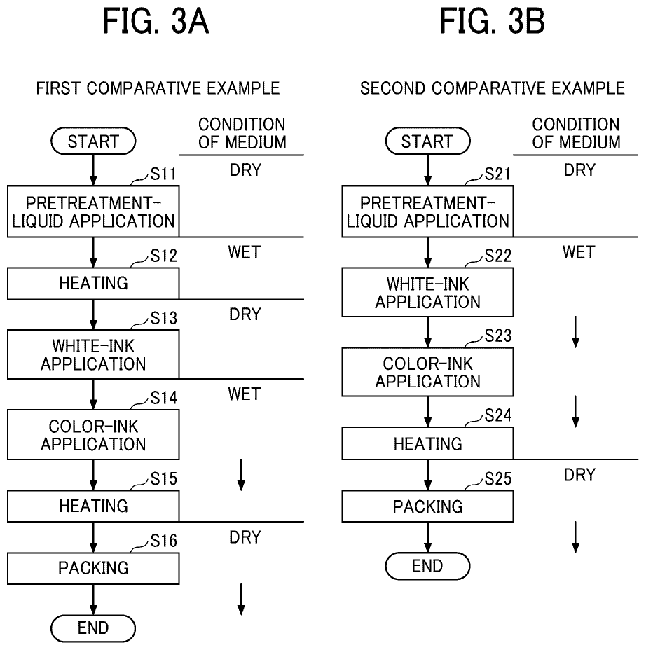

FIGS. 3A and 3B are flowcharts for explaining that a heating step can be removed by incorporating the pretreatment-liquid applier in a printing apparatus.

The flowchart in FIG. 3A illustrates a process (first comparative example) of using the printing apparatus not incorporating the pretreatment-liquid applier. Since a pretreatment-liquid application step S11, and a white-ink application step S13 and a color-ink application step S14 are performed by different apparatuses, a heating step S12 is performed therebetween. This is because, to increase productivity, a stock of cloth to which the pretreatment liquid has been applied and dried in the heating step S12 is prepared in advance to be printed with an image. After the color-ink application step S14, a heating step S15 is performed again, and a packing step S16 is performed to complete a product.

The flowchart in FIG. 3B illustrates a process (second comparative example) of using the printing apparatus incorporating the pretreatment-liquid applier. A pretreatment-liquid application step S21, a white-ink application step S22, and a color-ink application step S23 can be performed continuously as a series of processes. Accordingly, the heating step between the pretreatment-liquid application step and the white-ink application step can be omitted. After the color-ink application step S23, a heating step S24 is performed, and a packing step S25 is performed to complete a product. Compared with the process of using the printing apparatus not incorporating the pretreatment-liquid applier, the number of times of heating steps is small, and thus the process in FIG. 3B has high productivity. However, since the print target (i.e., a medium) is wet from the pretreatment-liquid application step S21 to the color-ink application step S23, when a large amount of the white ink is used as the base, the trace of ink seepage due to the spreading of the white ink may be formed outside the image forming area.

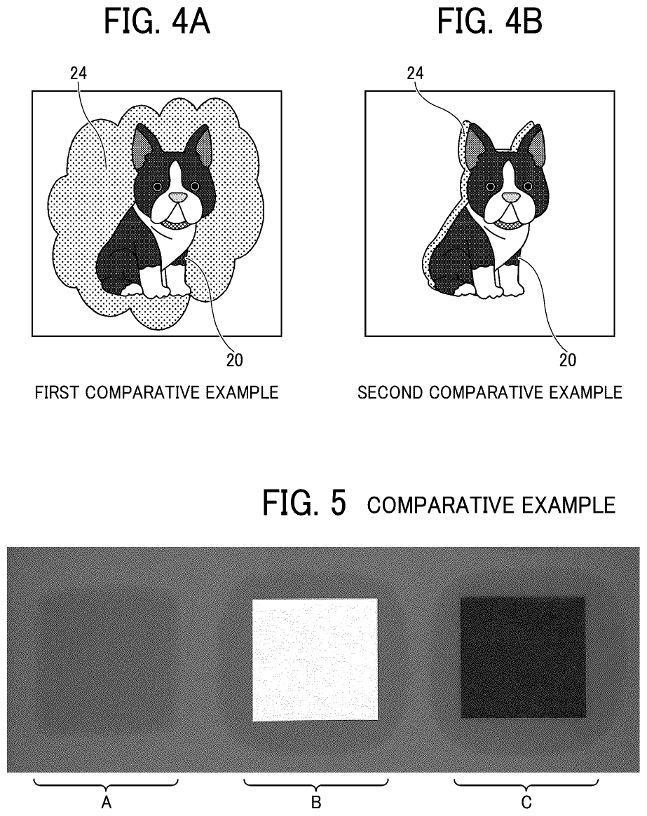

FIGS. 4A and 4B are diagrams each illustrating a relation between an area to which the pretreatment liquid is applied and an area on which a print image is formed.

FIG. 4A illustrates a pretreatment-liquid application area by the printing apparatus not incorporating the pretreatment-liquid applier (i.e., the first comparative example). The pretreatment-liquid application step is performed by an apparatus other than the apparatus that performs the white-ink application step and the color-ink application step, or by a manual operation using, for example, a hand spray, a brush, or a roller. For this reason, an image forming area 20 is often unclear when the pretreatment-liquid application step is performed. Accordingly, the pretreatment liquid is applied to a wide range of the color cloth so that the ink applied to the image forming area 20 contacts the pretreatment liquid. Accordingly, a pretreatment-liquid application area 24 spreads widely to the outside of the image forming area 20, and in some cases, a trace of ink seepage caused by the pretreatment liquid as occurred in a comparative example may occur due to unevenness when the pretreatment liquid is applied.

By contrast, FIG. 4B illustrates a pretreatment-liquid application area by a printing apparatus incorporating the pretreatment-liquid applier (i.e., the second comparative example). Since the pretreatment-liquid application step, the white-ink application step, and the color-ink application step are performed in the same apparatus, the pretreatment liquid can be discharged to the pretreatment-liquid application area 24 accurately adjusted to the image forming area 20. As a result, the printing apparatus incorporating the pretreatment-liquid applier can reduce the amount of pretreatment liquid. In addition, the trace of ink seepage is not formed. In FIG. 4B, the pretreatment-liquid application area 24 is illustrated at a position shifted from the image forming area 20 to illustrate the pretreatment-liquid application area 24. However, the pretreatment liquid is applied to an area coinciding with the image forming area 20.

FIG. 5 is a diagram illustrating a trace of ink seepage formed when the white ink is applied. FIG. 5 is a diagram illustrating photographs of areas A, B, and C on a color cloth after the following steps were performed and then the heating step was performed by the heat press device.

Area A: Only the pretreatment-liquid application step was performed to apply the pretreatment liquid onto the color cloth.

Area B: A white ink was further applied to form a base onto the area A onto which the pretreatment liquid has been applied.

Area C: On top of the area B (i.e., the base), a color ink was further applied to form a color image.

Each of the areas A, B, and C can be recognized as an area in which the trace of ink seepage is formed darker than the color of the cloth. When the traces of ink seepage in the areas A and B are compared, the trace of ink seepage in the area B is more widely spread, and it can be confirmed that the influence of the use of a large amount of the white ink is large. By contrast, there is almost no difference in the size of the trace of ink seepage between the areas B and C, and it can be confirmed that the formation of the color image by the color ink does not greatly affect the trace of ink seepage.

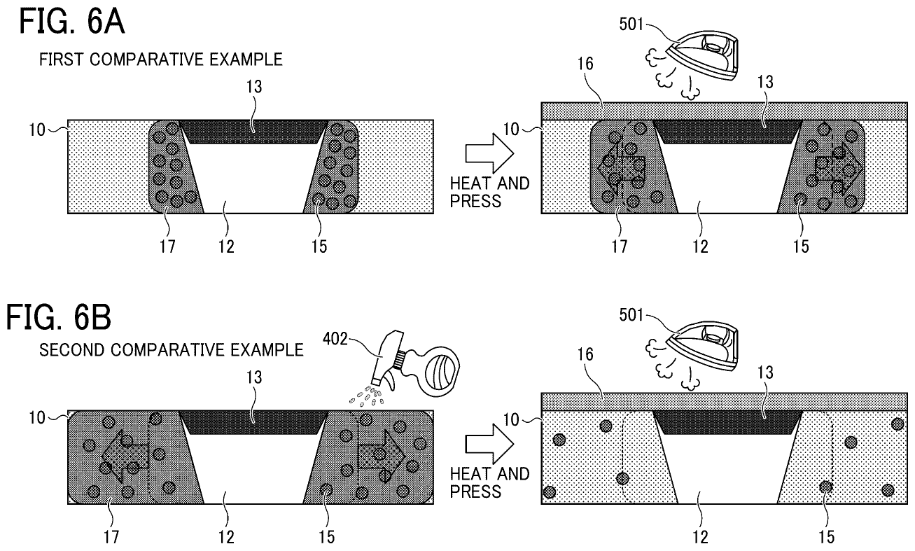

FIGS. 6A and 6B are diagrams each illustrating a process in which the trace of ink seepage is formed as viewed in a cross section of the color cloth. FIGS. 6A and 6B illustrate an example in which a heat press device 501 is employed as the heater.

FIG. 6A illustrates a process in which the trace of ink seepage is formed in a comparative technique (i.e., the first comparative example). A white ink 12 and a color ink 13 immediately after the color-ink application step, and an organic solvent 15 derived from the white ink 12 are distributed in the cross section of the color cloth 10 as illustrated on the left side of FIG. 6A. FIG. 6A is a schematic diagram illustrating the presence of the organic solvent 15. For this reason, the organic solvent 15 indicated by circles in FIGS. 6A and 6B does not indicate the shape of the organic solvent. The white ink 12 and the color ink 13 immediately after the color-ink application step have undergone a coagulation reaction due to the pretreatment liquid. However, the white ink 12 and the color ink 13 are only loosely solidified on the color cloth 10 until the white ink 12 and the color ink 13 are thermally cured by the heating step. The white ink 12 and the color ink 13 that are not yet sufficiently thermally cured are likely to peel off by physical force. However, the white ink 12 and the color ink 13 that are not yet sufficiently thermally cured are unlikely to peel off by the movement of moisture of the white ink 12 and the color ink 13 during the heating step.

In the heating step, the heat press device 501 heats and presses the white ink 12 and the color ink 13. By so doing, the white ink 12 and the color ink 13 are thermally cured to be firmly fixed to the cloth. When the heat press device 501, which causes a heat source to contact the color cloth 10 to heat the white ink 12 and the color ink 13, is employed, a heating and pressing step is performed via an impermeable sheet 16, such as a kitchen paper or a TEFLON (registered trademark) sheet, between the heat press device 501 and the color cloth 10 such that an image formed with the white ink 12 and the color ink 13 does not peel off by being attached to the heat source. A side of the color cloth 10 on which the image is formed is sealed with the impermeable sheet 16 and the opposite side of the color cloth 10 is sealed with a heating and pressing stage for the heat press device 501. Accordingly, the moisture evaporated by heating escapes in an in-plane direction of the color cloth 10. At this time, the organic solvent 15 also moves inside the color cloth 10 together with the moisture.

The temperature of the heat press device 501 is set to a temperature at which the color cloth 10 is not damaged (not melted or thermally denatured), and at which the moisture can be removed. For example, when the color cloth 10 is a polyester cloth, the temperature is set to about 100 to 120° C. All the moisture evaporates by the heating and pressing step using the heat press device 501. However, the organic solvent 15 has a high boiling point (for example, glycerin has a boiling point of about 290° C., and propanediol has a boiling point of about 190° C.). As a result, the organic solvent 15 remains inside the color cloth 10 as is, and a trace of ink seepage 17 is formed.

FIG. 6B illustrates a mechanism that can remove the trace of ink seepage by applying the colorless liquid (i.e., the second comparative example). When the heating and pressing is performed by the heat press device 501, the organic solvent 15 diffuses in the color cloth 10 together with the evaporated moisture. By using this phenomenon, applying additionally a colorless liquid including water can reduce the concentration of the organic solvent 15 in the color cloth 10. FIG. 6B illustrates an example in which water is sprayed using a hand spray 402 as the colorless-liquid applier. The organic solvent 15 diffuses in a wide range on the color cloth 10 by the application of water and the heating and pressing step by the heat press device 501. Accordingly, the concentration of the organic solvent 15 can be reduced to such an extent that the organic solvent 15 is not recognized as a trace of ink seepage.

As a concern at this time, the print image may be damaged (e.g., thinned, blurred, flowed, or shaved) due to the application of water. The white ink 12 and the color ink 13 are only loosely solidified on the color cloth 10 immediately after the white-ink application step and the color-ink application step. For this reason, strongly spraying or pouring water on the color cloth 10 may damage the print image and deteriorate printing quality. Water is applied to the surface of the print image in a non-contact manner, or sprayed to the surface of the print image at an angle at which impact to the print image is deflected, or fine spray droplets are sprayed to reduce the impact on the print image. By so doing, water can be applied to the print image without damaging the print image.

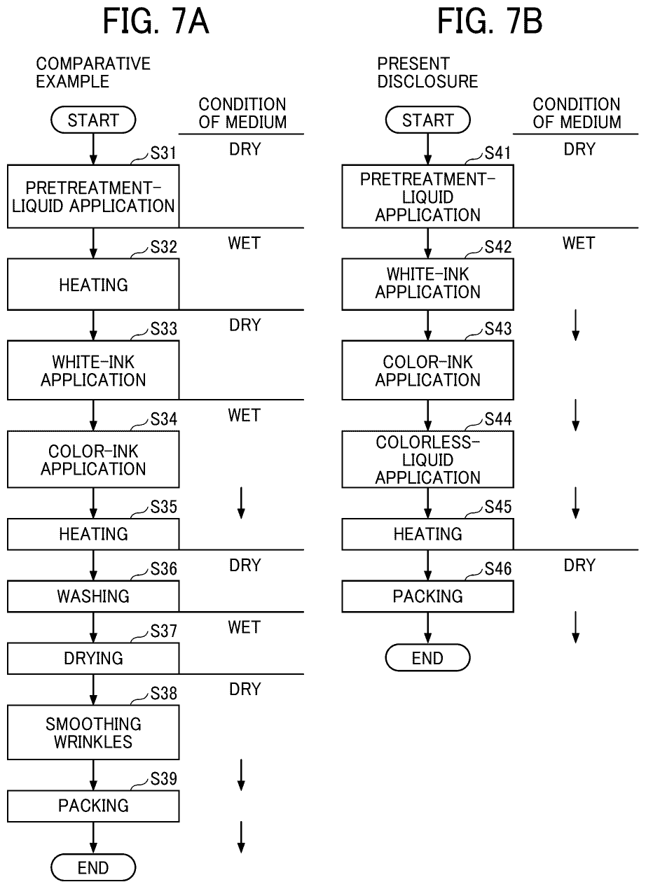

FIGS. 7A and 7B are flowcharts illustrating a printing method according to a comparative example and a printing method according to an embodiment of the present disclosure for comparing the number of steps in a method of removing the trace of ink seepage.

FIG. 7A is a flowchart of the printing method according to the comparative example. Steps S31 to S35 are performed in a similar manner to steps S11 to S15 illustrated in FIG. 3A. A washing step S36 is performed to remove the trace of ink seepage. Subsequently, a drying step S37 and a smoothing wrinkle step S38 are performed as additional steps, and then a packing step S39 is performed to complete a product. Accordingly, the total number of steps increases, and the productivity is low.

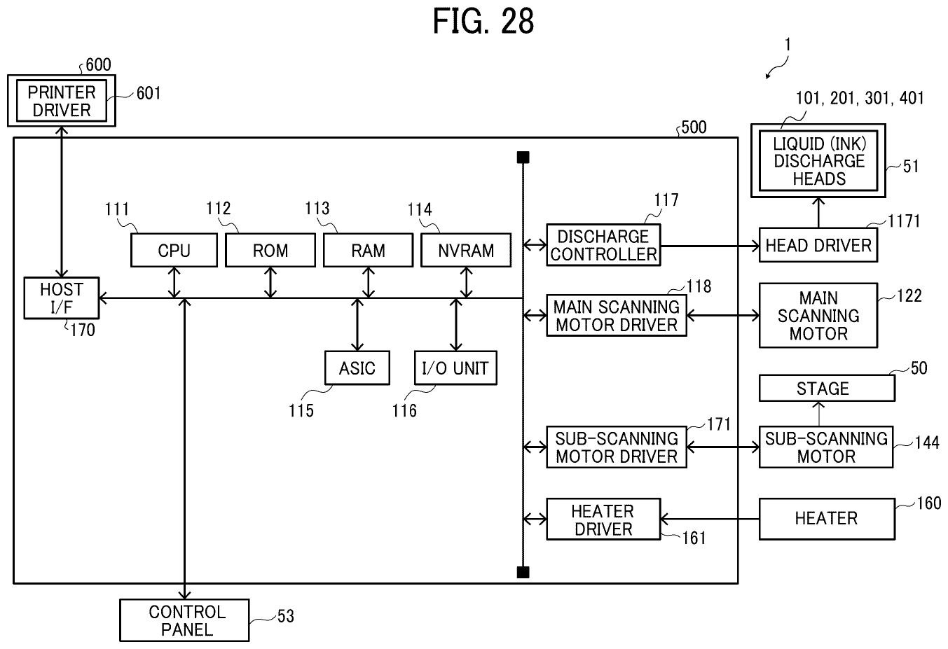

By contrast, FIG. 7B illustrates a flowchart of the printing method according to an embodiment of the present disclosure. Steps S41 to S43 are performed in a similar manner to steps S21 to S23 illustrated in FIG. 3B. A colorless-liquid application step S44 is performed to remove the trace of ink seepage. Subsequently, a heating step S45 is performed by the heater (e.g., a heater 160 included in the printing apparatus 1 illustrated in FIG. 28), and then a packing step S46 is performed to complete a product. Accordingly, the steps of washing, drying, and smoothing wrinkles in the comparative example are not performed in the present embodiment.

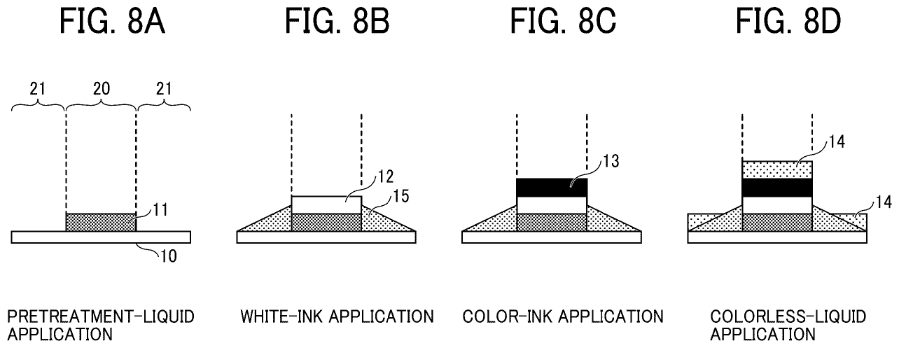

FIGS. 8A to 14C are diagrams illustrating the progress of the state of the surface of the color cloth classified for each timing of applying the colorless liquid. In FIGS. 8A to 14C, the pretreatment liquid, the white ink, and the color ink are illustrated as being laminated in layers on the color cloth for easy understanding of the printing process, but the pretreatment liquid, the white ink, and the color ink actually permeate into the color cloth.

FIGS. 8A to 8D are diagrams illustrating the progress of the state of the surface of the color cloth 10 when the colorless-liquid applier applies the colorless liquid 14 to the image forming area 20 and a trace of ink seepage area 21 in a case where the colorless-liquid applier applies the colorless liquid 14 after the color-ink applier applies the color ink 13. The organic solvent 15 contained in the white ink 12 used in a large amount as the base seeps out around the image forming area 20, but by applying the colorless liquid 14 including water to the trace of ink seepage area 21, the organic solvent 15 diffuses on the color cloth 10, and the trace of ink seepage is removed.

Since the white ink 12 and the color ink 13 react with the pretreatment liquid 11 and coagulate so as to be entangled with the fibers of the cloth, the ink layer (i.e., layers of the white ink 12 and the color ink 13) in the image forming area 20 is not damaged unless the colorless liquid 14 is applied to the image forming area 20 with a strong force that generates a physical pressure. By applying the colorless liquid to the image forming area 20 as well, stickiness caused by the solvent can be prevented.

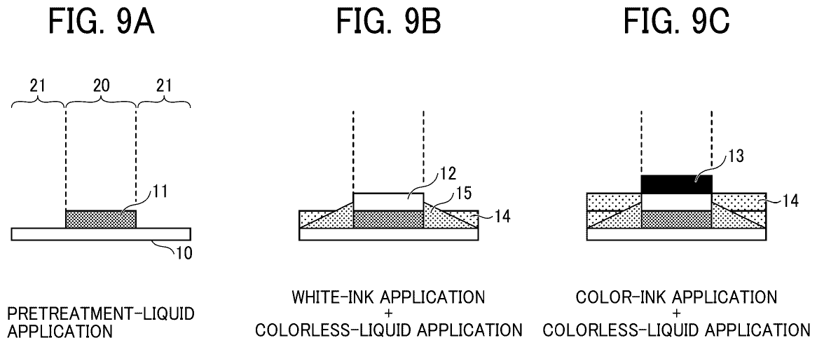

FIGS. 9A to 9C are diagrams illustrating the progress of the state of the surface of the color cloth 10 when the colorless-liquid applier applies the colorless liquid 14 not to the image forming area 20 but to the trace of ink seepage area 21 in a case where the colorless-liquid applier applies the colorless liquid 14 in parallel with the application of the white ink 12 by the white-ink applier and the application of the color ink 13 by the color-ink applier. Since the colorless liquid 14 is applied before the pretreatment liquid 11 reacts with the white ink 12 and the color ink 13, the colorless liquid 14 is not applied to the image forming area 20 so as not to damage the image.

By applying at least one of the white ink 12 or the color ink 13 in parallel with the application of the colorless liquid 14, productivity is enhanced. For example, in a printing method using an inkjet system, the number of layers of printing can be reduced.

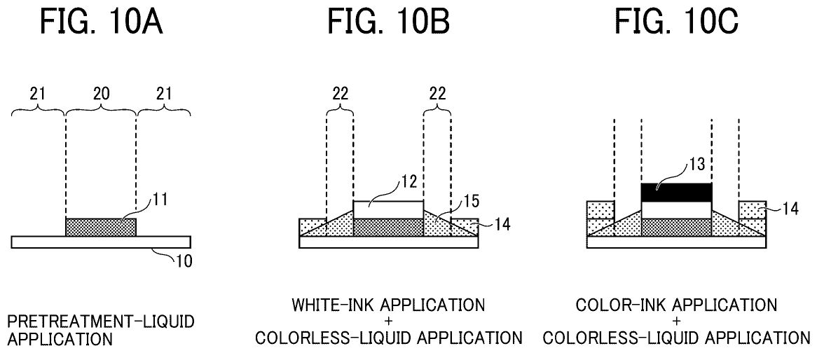

FIGS. 10A to 10C are diagrams illustrating the progress of the state of the surface of the color cloth 10 in a case where the colorless-liquid applier applies the colorless liquid 14 in parallel with the application of the white ink 12 by the white-ink applier and the application of the color ink 13 by the color-ink applier. In FIGS. 10A to 10C, a gap area 22 to which nothing (but seepage of the organic solvent seeping into the seepage area) is applied is formed between the image forming area 20 and the area to which the colorless liquid 14 is applied when the colorless-liquid applier applies the colorless liquid 14 to the trace of ink seepage area 21. The gap area 22 to which nothing is applied can reliably avoid the damage to an image due to the mixing of the ink (e.g., the white ink 12 or the color ink 13) and the colorless liquid 14.

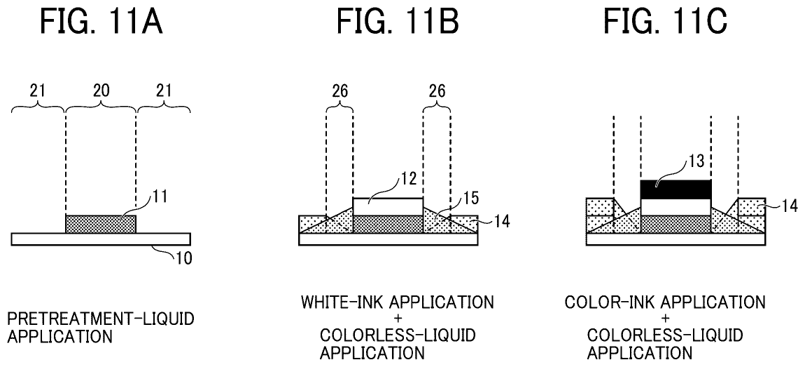

FIGS. 11A to 11C are diagrams illustrating the progress of the state of the surface of the color cloth 10 in a case where the colorless-liquid applier applies the colorless liquid 14 in parallel with the application of the white ink 12 by the white-ink applier and the application of the color ink 13 by the color-ink applier. In FIGS. 11A to 11C, a sloped area 26 in which a smaller amount of the colorless liquid 14 is applied to a position closer to the image forming area 20 is formed around the image forming area 20 when the colorless-liquid applier applies the colorless liquid 14 to the trace of ink seepage area 21. As a result, the damage to an image due to the mixing of the ink (e.g., the white ink 12 or the color ink 13) and the colorless liquid 14 can be minimized. In addition, the trace of ink seepage can be effectively removed as compared with the case illustrated in FIGS. 10A to 10C.

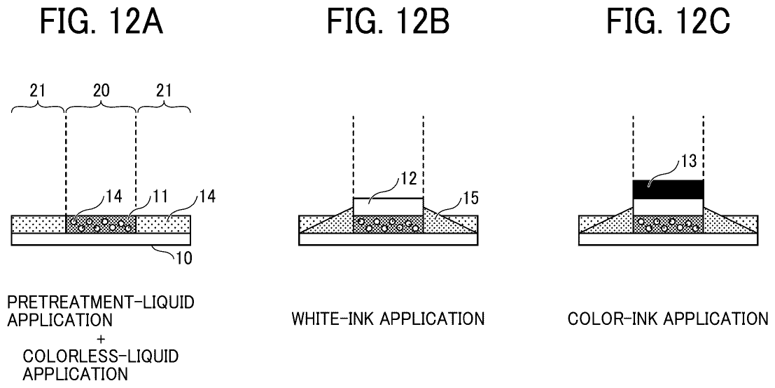

FIGS. 12A to 12C are diagrams illustrating the progress of the state of the surface of the color cloth 10 when the colorless-liquid applier applies the colorless liquid 14 to the image forming area 20 and the trace of ink seepage area 21 in a case where the colorless-liquid applier applies the colorless liquid 14 before the white-ink applier applies the white ink 12. In FIGS. 12A to 12C, the pretreatment-liquid application area is the same as the image forming area 20.

By applying the colorless liquid 14 to the pretreatment-liquid application area as well, the pretreatment liquid 11 can be diluted on the color cloth 10. According to this printing method, the pretreatment liquid can be evenly applied onto the cloth into which the pretreatment liquid does not smoothly permeate, and thus the image quality and washing fastness can be enhanced.

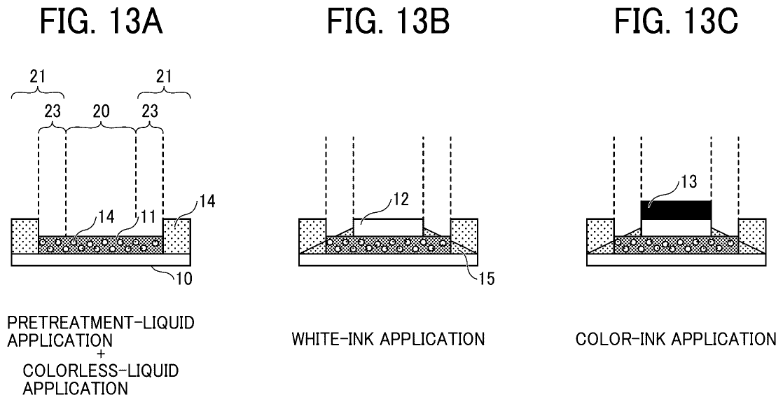

FIGS. 13A to 13C are diagrams illustrating the progress of the state of the surface of the color cloth 10 when the colorless-liquid applier applies the colorless liquid 14 to an area around an extended area 23 in a case where the colorless-liquid applier applies the colorless liquid 14 before the white-ink applier applies the white ink 12, and the pretreatment-liquid applier applies the pretreatment liquid 11 not only to the image forming area 20 but also to the extended area 23 before the white-ink applier applies the white ink 12. Since the colorless liquid 14 is applied before the white ink 12 and the color ink 13 are applied, if the same amount of the colorless liquid 14 as an amount for removing the trace of ink seepage is applied to the pretreatment-liquid application area including the extended area 23, the pretreatment liquid 11 is diluted, and insufficient coloring of the ink (e.g., the white ink 12 or the color ink 13) may occur. In FIGS. 13A to 13C, a small amount of the colorless liquid 14, which does not cause insufficient coloring of the ink, is applied to the pretreatment-liquid application area (i.e., the image forming area 20 and the extended area 23) to dilute the pretreatment liquid 11.

Since the pretreatment-liquid applier applies the pretreatment liquid 11 to an area wider than the image forming area 20, the influence of the landing positional deviation between the pretreatment liquid 11 and the ink (e.g., the white ink 12 or the color ink 13) can be reduced.

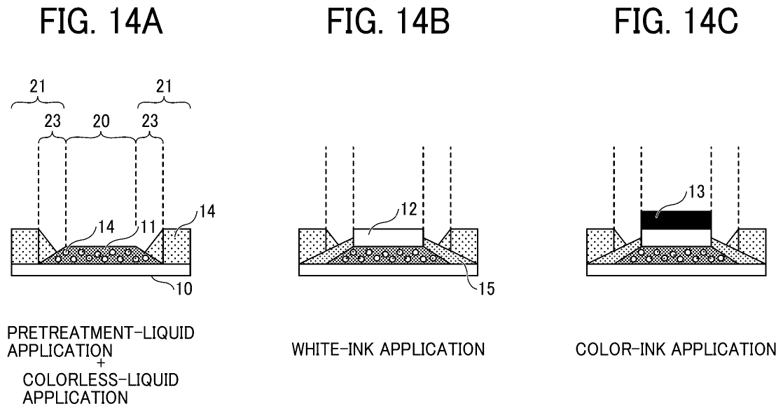

FIGS. 14A to 14C are diagrams illustrating the progress of the state of the surface of the color cloth 10 when the colorless-liquid applier applies the colorless liquid 14 not only to an area around the extended area 23 but also to the extended area 23. In FIGS. 14A to 14C, the colorless-liquid applier applies the colorless liquid 14 before the white-ink applier applies the white ink 12, and the pretreatment-liquid applier applies the pretreatment liquid 11 not only to the image forming area 20 but also to the extended area 23 before the white-ink applier applies the white ink 12. Further, a smaller amount of the colorless liquid 14 is applied and a larger amount of the pretreatment liquid 11 is applied to a position closer to the image forming area 20 in the extended area 23. Since the colorless liquid 14 is applied before the white ink 12 and the color ink 13 are applied, if the same amount of the colorless liquid 14 as an amount for removing the trace of ink seepage is applied to the pretreatment-liquid application area including the extended area 23, the pretreatment liquid 11 is diluted, and insufficient coloring of the ink (e.g., the white ink 12 or the color ink 13) may occur. In FIGS. 14A to 14C, a small amount of the colorless liquid 14, which does not cause insufficient coloring of the ink, is applied to the pretreatment-liquid application area (i.e., the image forming area 20 and the extended area 23) to dilute the pretreatment liquid 11. As compared with the case illustrated in FIGS. 13A to 13C, the trace of ink seepage can be effectively removed by applying the colorless liquid 14 to the extended area 23 as well.

FIG. 15 is a diagram illustrating an area to which the colorless liquid is applied. The width of a colorless-liquid application area 25 (i.e., the colorless-liquid area) is preferably twice or greater than the width of the trace of ink seepage area 21. The width of the colorless-liquid application area 25, which is twice or greater than the width of the trace of ink seepage area 21, allows the organic solvent to diffuse on the color cloth 10 to such an extent that the trace of ink seepage is not recognized. The colorless-liquid application area 25 may include the image forming area 20 or may be an entire surface of the color cloth 10 as long as the print image is not physically damaged.

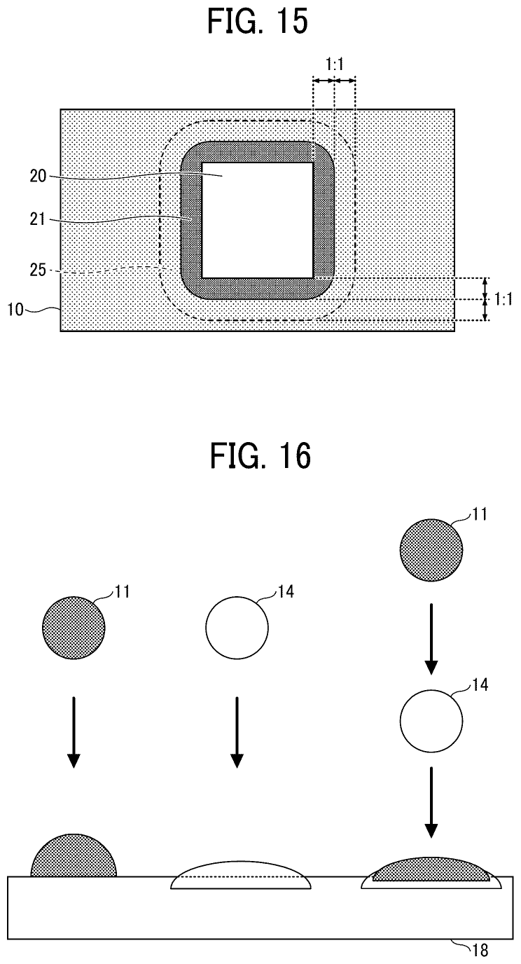

FIG. 16 is a conceptual diagram of the dilution of the pretreatment liquid by the discharge of the colorless liquid. The pretreatment liquid including a coagulation component, a resin, or a solvent (glycerin) has a higher viscosity than water and is less likely to wet and spread than water. Accordingly, on a cloth 18, the pretreatment liquid 11 does not smoothly permeate into the cloth 18, and a surface covering area of the pretreatment liquid 11 is small as illustrated in the left side of FIG. 16. As illustrated in the middle and the right side of FIG. 16, when the colorless liquid 14 including water and the pretreatment liquid 11 are discharged onto the cloth 18 in this order so as to overlap dots of the colorless liquid 14 and the pretreatment liquid 11, the colorless liquid 14 wets and spreads on the cloth 18, and the pretreatment liquid 11 wets and spreads widely through the water of the colorless liquid 14 spread on the cloth 18. As a result, the surface covering area of the pretreatment liquid 11 can be increased.

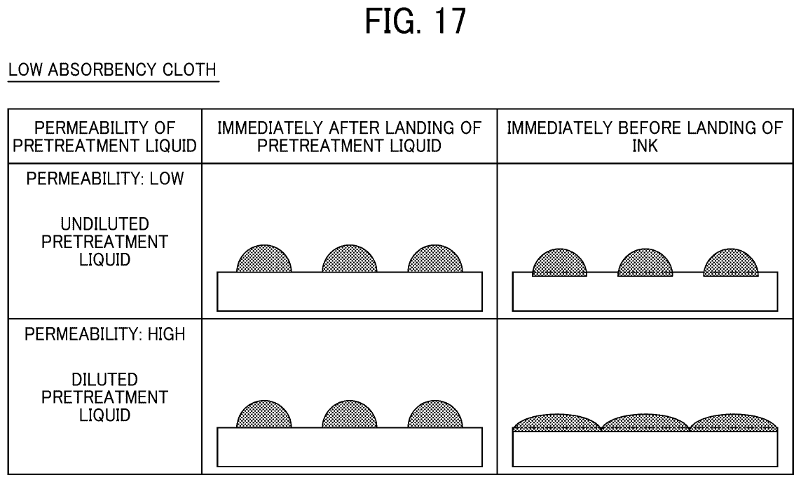

FIG. 17 illustrates cross-sectional views of a cloth when the pretreatment liquid is applied to the cloth having low absorbency. Undiluted pretreatment liquid having low permeability is unlikely to spread on the cloth, and an area in which the pretreatment liquid is not applied is generated. The coagulation caused by the reaction between the pretreatment liquid and the ink does not sufficiently proceed, which may cause the deterioration in the image quality and washing fastness. By contrast, diluted pretreatment liquid enhances permeability and is likely to spread on the cloth. As a result, the pretreatment liquid can be evenly applied onto the surface of the cloth, and thus the image quality and washing fastness are enhanced.

However, when the amount of the colorless liquid used for diluting the pretreatment liquid is large, a coagulation effect of the pretreatment liquid may deteriorate, and the image quality and washing fastness may deteriorate. For this reason, the amount of the colorless liquid used for diluting the pretreatment liquid is preferably three times or less the amount of the pretreatment liquid.

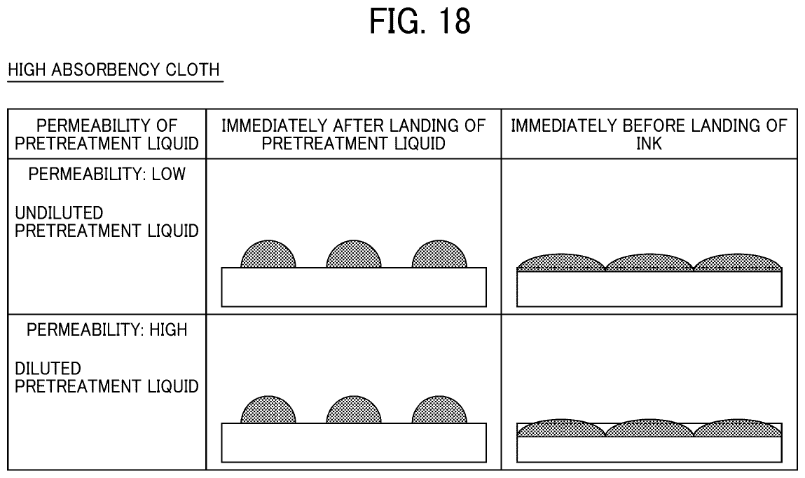

FIG. 18 illustrates cross-sectional views of a cloth when the pretreatment liquid is applied to the cloth having high absorbency. In a case of the cloth having high absorbency, when the pretreatment liquid is diluted, the pretreatment liquid is excessively absorbed by the cloth, and components of the pretreatment liquid do not sufficiently remain on the surface of the cloth. In this case, coagulation due to the reaction between the pretreatment liquid and the ink may not sufficiently proceed, which causes the deterioration in the image quality and washing fastness. For this reason, when printing is performed on the cloth having high absorbency, preferably, the pretreatment liquid is not diluted with the colorless liquid.

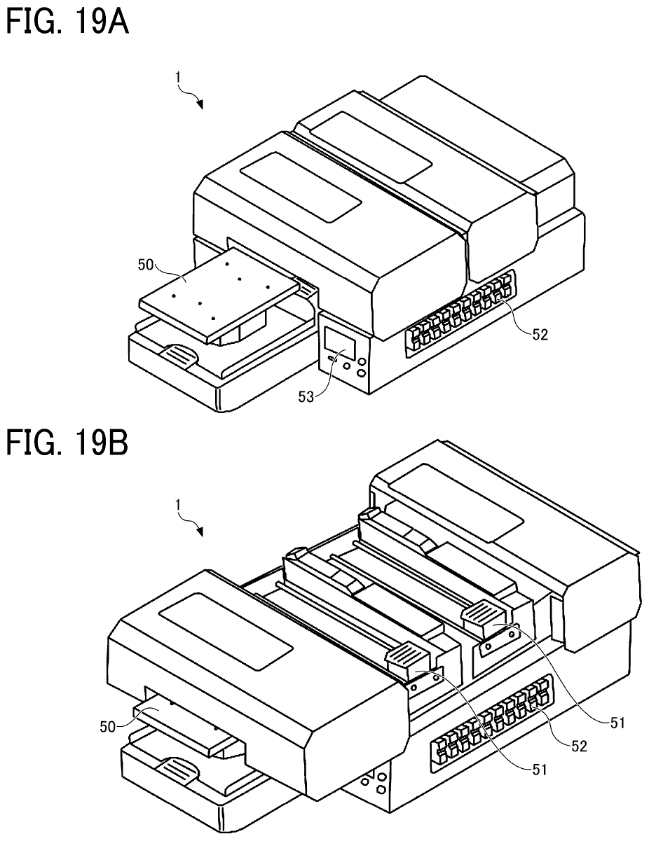

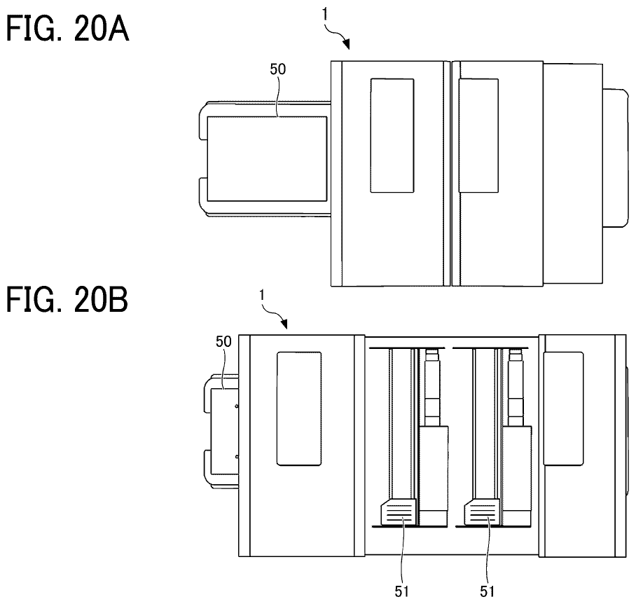

FIGS. 19A and 19B are perspective views of a printing apparatus using an inkjet system, according to an embodiment of the present disclosure. FIGS. 20A and 20B are top views of the printing apparatus of FIGS. 19A and 19B, respectively.

The printing apparatus 1 includes a stage (platen) 50, a carriage 51, a cartridge 52, and a control panel 53. FIGS. 19A and 19B and FIGS. 20A and 20B illustrate the printing apparatus having a double carriage configuration in which two carriages 51 are mounted, but the number of carriages may be one, or three or more.

The stage 50 is a plate-shaped component that supports a medium on the upper surface thereof. The stage 50 is supported by a housing of the printing apparatus 1. The stage 50 is vertically movable and slidable in a sub-scanning direction (front-rear direction) orthogonal to the vertical direction and a main scanning direction (transverse direction). The stage 50 is moved in the sub-scanning direction by a sub-scanning motor 144 (see FIG. 28).

The carriage 51 is disposed above the stage 50. Discharge heads that discharge the pretreatment liquid, the white ink, the color ink, and the colorless liquid from nozzles are mounted on the lower face of the carriage 51. The pretreatment liquid, the white ink, the color ink, and the colorless liquid are stored in the cartridge 52 via a supply tube. The carriage 51 supported by the housing of the printing apparatus 1 is reciprocally movable in the main scanning direction (transverse direction) orthogonal to the vertical direction and the sub-scanning direction (front-rear direction). The carriage 51 is moved in the main scanning direction by a main scanning motor 122 (see FIG. 28). While the carriage 51 reciprocally moves in the main scanning direction, the pretreatment liquid, the white ink, the color ink, and the colorless liquid are discharged from the discharge head at a predetermined timing, so that an image is formed on the medium supported by the stage 50 located below the discharge head.

The control panel 53 includes an operation section that receives an input operation from the user and a display that notifies the user of information. Examples of the operation section include hard keys and a touch panel superimposed on the display. The control panel 53 acquires information from the user through the operation section and provides information for the user through the display.

### Configuration of Control Block

A configuration of a control block of the printing apparatus 1 will be described below with reference to FIG. 28. As illustrated in FIG. 28, the controller 500 as a control block of the printing apparatus 1 includes a central processing unit (CPU) 111, a read-only memory (ROM) 112, a random-access memory (RAM) 113, a nonvolatile random-access memory (NVRAM) 114, and an application-specific integrated circuit (ASIC) 115.

The CPU 111 is connected to the control panel 53 as an operation display unit for inputting and displaying information for the printing apparatus 1, and controls the operation of each functional component of the printing apparatus 1. The CPU 111 also has functions of controlling a conveyance operation of the stage 50 in the sub-scanning direction, a movement operation of the carriage 51 in the main scanning direction, and the liquid discharge operation by the discharge heads.

The ROM 112 is a non-volatile storage medium that stores programs executed by the CPU 111 and other fixed data. The controller 500 is implemented by executing the programs stored in the ROM 112 by the arithmetic processing function of the CPU 111. The RAM 113 temporarily stores, for example, image data used for an image forming process. The RAM 113 also functions as a work area when a program controller is implemented. The NVRAM 114 is a rewritable non-volatile storage medium that can retain data even while the printing apparatus 1 is powered off. The ASIC 115 performs image processing, such as various signal processing and sorting on image data, and processing of input and output signals for controlling the entire of the printing apparatus 1.

The controller 500 further includes a host interface (I/F) 170, a discharge controller 117, a main scanning motor driver 118, a sub-scanning motor driver 171, a heater driver 161, and an input/output (I/O) unit 116. The host I/F 170 transmits and receives data and control signals to and from a host, such as a printer driver 601 of an external apparatus 600.

The discharge controller 117 generates a drive waveform to drive the discharge heads and outputs the image data for selectively driving pressure generators of the discharge heads and various types of data associated with the image data to a head driver 1171.

The main scanning motor driver 118 drives the main scanning motor 122. The heater driver 161 drives the heater 160 to heat a color image formed on the color cloth 10. The sub-scanning motor driver 171 drives the sub-scan motor 144 to move the stage 50 in the sub-scanning direction. The I/O unit 116 receives detection signals from various sensors for the operation of the printing apparatus 1.

The controller 500 receives an image forming instruction related to the image forming process from the printer driver 601 of the external apparatus 600 via a cable or a network by the host I/F 170. The printer driver 601 of the external apparatus 600 generates the image forming instruction. The external apparatus 600 has a host function of an information processing apparatus such as a personal computer (PC), an image reading device such as an image scanner, and an image capture such as a digital camera.

As the controller 500 receives the image forming instruction, the CPU 111 reads and analyzes the image forming instruction in the reception buffer of the host I/F 170. The ASIC 115 performs, for example, desired image processing and data-sorting processing and transfers the image forming instruction to the discharge controller 117 according to an analysis result of the CPU 111. The discharge controller 117 outputs the image data and the drive waveform to the head driver 1171 at a predetermined timing. Dot pattern data for image output may be generated by storing font data in, for example, the ROM 112. The printer driver 601 may develop the image data into bitmap data and transfer to the printing apparatus 1 to generate the dot pattern data. In the present embodiment, for example, it is assumed that the printer driver 601 generates the dot pattern data for image output. According to the above, the image forming instruction corresponds to discharge instruction information.

A drive waveform generator of the discharge controller 117 includes a digital-to-analog (D/A) converter and an amplifier. The D/A converter converts pattern data of drive pulses stored in the ROM 112 and read by the CPU 111 from digital data to analog data. The drive waveform generator of the discharge controller 117 outputs the drive waveform including one drive pulse or multiple drive pulses to the head driver 1171. The head driver 1171 drives the discharge heads based on the image data (dot pattern data) corresponding to one line printed by the discharge heads. The image data is serially input to the head driver 1171. The head driver 1171 selectively applies the drive pulses of the drive waveform received from the drive waveform generator of the discharge controller 117 to the pressure generator of the discharge heads.

The head driver 1171 includes, for example, a shift register to which a clock signal and serial data as image data are input, and a latch circuit that latches a resist value of the shift register by a latch signal. In addition, the head driver 1171 includes a level conversion circuit (level shifter) that changes the level of the output value of the latch circuit and an analog switch array (switch) that is controlled to be turned on or turned off by the level shifter. Functionally, for example, the head driver 1171 controls turning ON or turning OFF of the analog switch array to selectively apply a desired drive pulse in the drive waveform to the pressure generator of the discharge heads.

The image forming instruction (operation instruction information) includes information indicating the type of the color cloth 10. The discharge controller 117 of the controller 500 of the printing apparatus 1 has a function of selecting and determining the amount of the pretreatment liquid 11 corresponding to the discharge amount of the white ink 12 or the color ink 13, according to the type of the color cloth 10 placed on the stage 50. Further, the discharge controller 117 adjusts (changes) an area to which the colorless liquid 14 is applied (i.e., the colorless liquid area) and change the amount of the colorless liquid 14. For example, the discharge controller 117 decreases the amount of the colorless liquid 14 applied to the colorless-liquid area including the seepage area around the image forming area by the colorless-liquid applier with a decrease in the amount of the white ink 12 applied to the image forming area by the white-ink applier.

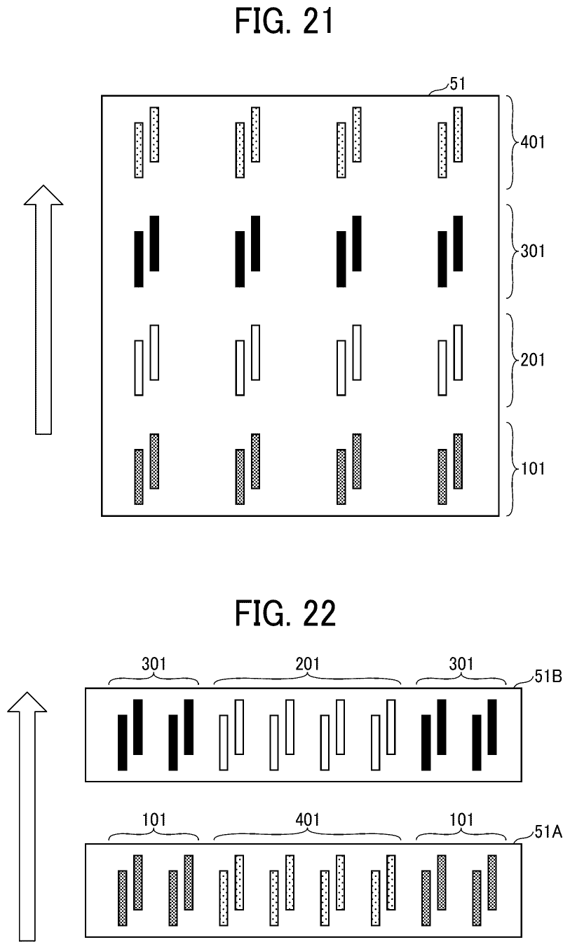

In FIG. 28, the discharge heads such as a pretreatment-liquid discharge head 101, a white-ink discharge head 201, a color-ink discharge head 301, and a colorless-liquid discharge head 401 are mounted on the carriage 51. However, the pretreatment-liquid discharge head 101, the white-ink discharge head 201, the color-ink discharge head 301, and the colorless-liquid discharge head 401 may be separately mounted multiple carriages as illustrated in FIGS. 22 to 27. The pretreatment-liquid discharge head 101, the white-ink discharge head 201, the color-ink discharge head 301, and the colorless-liquid discharge head 401 are examples of the pretreatment-liquid applier 100, the white-ink applier 200, the color-ink applier 300, and the colorless-liquid applier 400, respectively.

FIGS. 21 to 27 are diagrams each illustrating a configuration of a carriage of the printing apparatus using an inkjet system.

FIG. 21 is a diagram illustrating a single carriage configuration in which the pretreatment-liquid discharge head 101, the white-ink discharge head 201, the color-ink discharge head 301, and the colorless-liquid discharge head 401 are mounted on one carriage 51. By arranging the pretreatment-liquid discharge head 101, the white-ink discharge head 201, the color-ink discharge head 301, and the colorless-liquid discharge head 401 in this order in a conveyance direction of the medium indicated by the blank arrow, printing can be completed while the medium is conveyed in one direction, thus allowing high productivity.

FIGS. 22 and 23 are diagrams each illustrating a double carriage configuration including two carriages.

FIG. 22 is a diagram illustrating a carriage configuration in which the pretreatment-liquid discharge head 101 and the colorless-liquid discharge head 401 are mounted on a first carriage 51A, and the white-ink discharge head 201 and the color-ink discharge head 301 are mounted on a second carriage 51B. Since the pretreatment-liquid discharge head 101 and the colorless-liquid discharge head 401 are mounted on the same carriage (i.e., the first carriage 51A), the pretreatment-liquid application step and the colorless-liquid application step can be performed in parallel.

FIG. 23 is a diagram illustrating a carriage configuration in which the pretreatment-liquid discharge head 101 is mounted on the first carriage 51A, and the white-ink discharge head 201, the color-ink discharge head 301, and the colorless-liquid discharge head 401 are mounted on the second carriage 51B. Since the white-ink discharge head 201, the color-ink discharge head 301, and the colorless-liquid discharge head 401 are mounted on the same carriage (i.e., the second carriage 51B), at least one of the white-ink application step or the color-ink application step, and the colorless-liquid application step can be performed in parallel.

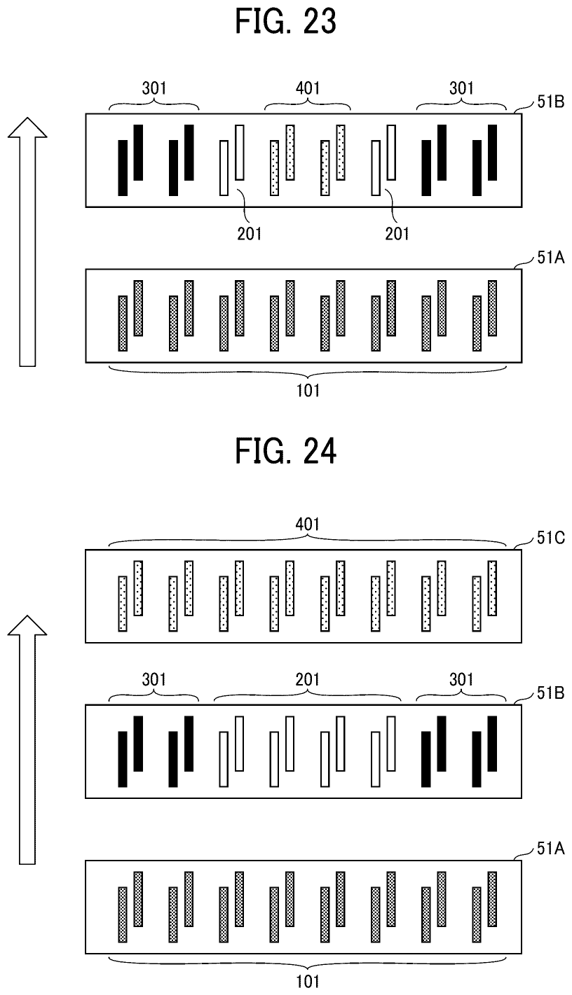

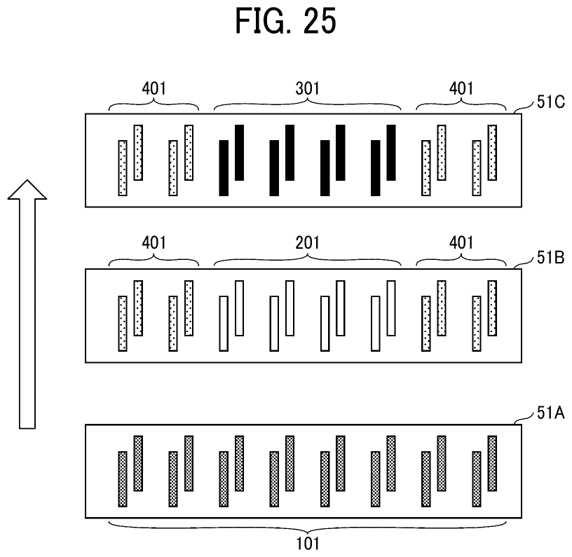

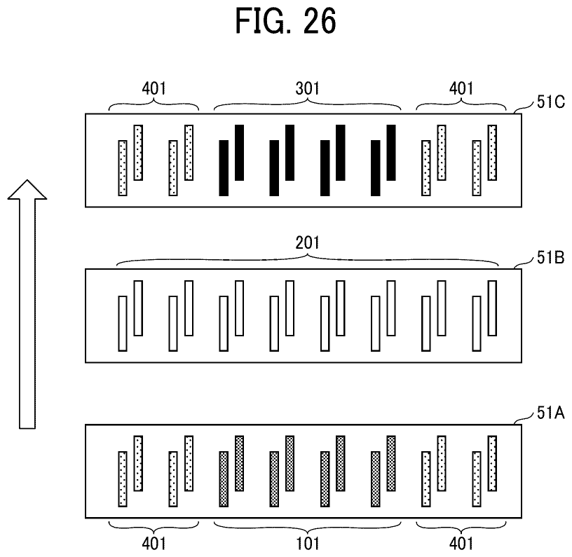

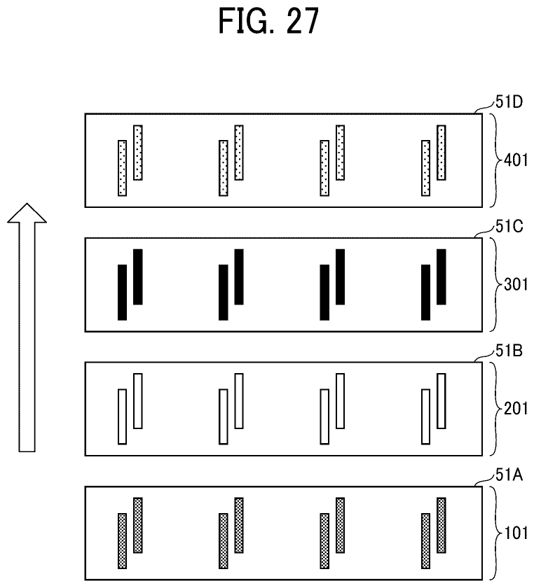

FIGS. 24 to 26 are diagrams each illustrating a triple carriage configuration including three carriages.

FIG. 24 is a diagram illustrating a carriage configuration in which the pretreatment-liquid discharge head 101 is mounted on the first carriage 51A, the white-ink discharge head 201 and the color-ink discharge head 301 are mounted on the second carriage 51B, and the colorless-liquid discharge head 401 is mounted on a third carriage 51C. Since the white-ink discharge head 201 and the color-ink discharge head 301 are mounted on the same carriage (i.e., the second carriage 51B), the medium is conveyed in a reverse direction opposite to the conveyance direction after the white-ink discharge head 201 discharges the white ink, and then the color-ink discharge head 301 discharges the color ink.

FIG. 25 is a diagram illustrating a carriage configuration in which the pretreatment-liquid discharge head 101 is mounted on the first carriage 51A, the white-ink discharge head 201 and the colorless-liquid discharge head 401 are mounted on the second carriage 51B, and the color-ink discharge head 301 and the colorless-liquid discharge head 401 are mounted on the third carriage 51C. Since the colorless-liquid discharge head 401 is mounted on the same carriage (i.e., the second carriage 51B or the third carriage 51C) on which either one of the white-ink discharge head 201 or the color-ink discharge head 301 is mounted, at least one of the white-ink application step or the color-ink application step, and the colorless-liquid application step can be performed in parallel.

FIG. 26 is a diagram illustrating a carriage configuration in which the pretreatment-liquid discharge head 101 and the colorless-liquid discharge head 401 are mounted on the first carriage 51A, the white-ink discharge head 201 is mounted on the second carriage 51B, and the color-ink discharge head 301 and the colorless-liquid discharge head 401 are mounted on the third carriage 51C. Since the pretreatment-liquid discharge head 101 and the colorless-liquid discharge head 401 are mounted on the same carriage (i.e., the first carriage 51A), the pretreatment-liquid application step and the colorless-liquid application step can be performed in parallel. Since the color-ink discharge head 301 and the colorless-liquid discharge head 401 are mounted on the same carriage (i.e., the third carriage 51C), the color-ink application step and the colorless-liquid application step can be performed in parallel.

FIG. 27 is a diagram illustrating a quattro carriage configuration in which the pretreatment-liquid discharge head 101 is mounted on the first carriage 51A, the white-ink discharge head 201 is mounted on the second carriage 51B, the color-ink discharge head 301 is mount on the third carriage 51C, and the colorless-liquid discharge head 401 is mounted on a fourth carriage 51D. As in the case of the single carriage configuration illustrated in FIG. 21, the medium is not conveyed in the reverse direction, thus allowing high productivity.

When the colorless-liquid discharge head 401 is mounted on the same carriage on which at least one of the pretreatment-liquid discharge head 101, the white-ink discharge head 201, or the color-ink discharge head 301 is mounted, each of the pretreatment-liquid application step, the white-ink application step, and the color-ink application step is not necessarily performed in parallel with the colorless-liquid application step, and the user can freely select steps performed in parallel depending on the intended purpose. For example, in the carriage configuration illustrated in FIG. 26, the colorless-liquid application step and the pretreatment-liquid application step may be performed in parallel, and the color-ink application step and the colorless-liquid application step may not be performed in parallel. Alternatively, the colorless-liquid application step and the pretreatment-liquid application step may not be performed in parallel, and the color-ink application step and the colorless-liquid application step may be performed in parallel.

The double carriage and triple carriage configurations can make the printing apparatus smaller than the quattro carriage configuration due to the small number of carriages.

The double carriage and triple carriage configurations can enhance the reliability when liquid is discharged from the nozzle as compared with the single carriage configuration. For example, when the pretreatment liquid is discharged, the white ink and the color ink are not discharged. Accordingly, the white ink and the color ink are likely to dry in the nozzle. As a result, the single carriage configuration may cause nozzle clogging due to ink adhering to the nozzle.

Aspects of the present disclosure are, for example, as follows.

### Aspect 1

A printing apparatus includes a pretreatment-liquid applier that applies a pretreatment liquid to a predetermined area on a permeable print target onto which printing is performed, a white-ink applier that applies a white ink to a predetermined area on the area to which the pretreatment liquid is applied to form a base of the white ink, a color-ink applier that applies a color ink to a predetermined area on the base of the white ink to form a color image, and a colorless-liquid applier that applies a colorless liquid including water to a predetermined area including at least a part of a trace of ink seepage area around an image forming area. The printing apparatus adjusts the area to which the colorless liquid is applied according to a timing of applying the colorless liquid.

In other words, a printing apparatus includes a pretreatment-liquid applier, a white-ink applier, a color-ink applier, a colorless-liquid applier, and circuitry. The pretreatment-liquid applier applies a pretreatment liquid to a pretreatment area in a permeable print target to form a pretreatment layer. The white-ink applier applies a white ink including an organic solvent to an image forming area in the pretreatment area to form a base layer of the white ink on the pretreatment layer. The organic solvent seeps into a seepage area around the image forming area to form the seepage area. The color-ink applier applies a color ink including an organic solvent to the image forming area to form a color image on the base layer of the white ink. The colorless-liquid applier applies a colorless liquid including water to a colorless-liquid area including at least a part of the seepage area. The circuitry changes the colorless-liquid area according to a timing of applying the colorless liquid to the colorless-liquid area in a process of applying the pretreatment liquid, the white ink, and the color ink to the permeable print target.

### Aspect 2

In the printing apparatus of Aspect 1, after the color-ink applier applies the color ink, the colorless-liquid applier applies the colorless liquid. The colorless liquid is applied to the image forming area and the trace of ink seepage area.

In other words, the circuitry controls the colorless-liquid applier to apply the colorless liquid to the colorless-liquid area including the image forming area and the seepage area after controlling the color-ink applier to apply the color ink to the image forming area.

### Aspect 3

In the printing apparatus of Aspect 1, the colorless-liquid applier applies the colorless liquid in parallel with at least one of application of the white ink by the white-ink applier and application of the color ink by the color-ink applier. The colorless liquid is not applied to the image forming area.

In other words, the circuitry controls the colorless-liquid applier to apply the colorless liquid to the colorless-liquid area including the seepage area except the image forming area while controlling at least one of the white-ink applier to apply the white ink or the color-ink applier to apply the color ink to the image forming area.

### Aspect 4

In the printing apparatus of Aspect 1, before the white-ink applier applies the white ink, the colorless-liquid applier applies the colorless liquid. The colorless liquid is applied not only to at least a part of the trace of ink seepage area but also to a predetermined area on a pretreatment-liquid application area.

In other words, the circuitry controls the colorless-liquid applier to apply the colorless liquid to the colorless-liquid area including at least a part of the seepage area and the pretreatment area before controlling the white-ink applier to apply the white ink to the image forming area.

### Aspect 5

In the printing apparatus of any one of Aspects 1 to 4, the circuitry changes an amount of the colorless liquid applied to the colorless-liquid area according to a timing of applying the colorless liquid to the colorless-liquid area in the process of applying the pretreatment liquid, the white ink, and the color ink to the permeable print target.

### Aspect 6

In the printing apparatus of any one of Aspects 1 to 5, an amount of the colorless liquid applied by the colorless-liquid applier is made smaller in an area in which an amount of the white ink applied by the white-ink applier is smaller.

In other words, the circuitry controls the colorless-liquid applier to decrease the amount of the colorless liquid applied to the colorless-liquid area including the seepage area around the image forming area with a decrease in an amount of the white ink applied to the image forming area by the white-ink applier.

### Aspect 7

The printing apparatus of any one of Aspects 1 to 6 further includes a heater that performs heating after an image is formed.

In other words, the printing apparatus according to any one of Aspects 1 to 6, further includes a heater to heat the color image on the permeable print target.

### Aspect 8

In the printing apparatus of any one of Aspects 1 to 7, the circuitry controls the colorless-liquid applier to form a gap area to which nothing but seepage of the organic solvent seeping into the seepage area is applied between the image forming area and the colorless-liquid area in the seepage area when the colorless-liquid applier applies the colorless liquid to the seepage area.

### Aspect 9

In the printing apparatus of any one of Aspects 1 to 7, the circuitry controls the colorless-liquid applier to gradually reduce an amount of the colorless liquid, applied to the seepage area, toward the image forming area to form a sloped area in the seepage area around the image forming area.

### Aspect 10

In the printing apparatus of any one of Aspects 1 to 7, the circuitry controls the pretreatment-liquid applier to gradually increase an amount of the pretreatment liquid, which is applied to the pretreatment area including an extended area outside the image forming area, toward the image forming area, and controls the colorless-liquid applier to gradually reduce an amount of the colorless liquid applied to the extended area toward the image forming area.

### Aspect 11

In the printing apparatus of any one of Aspects 1 to 10, further includes a first carriage mounting at least one of the pretreatment-liquid applier, the white-ink applier, the color-ink applier, or the colorless-liquid applier, and a second carriage mounting a rest of the pretreatment-liquid applier, the white-ink applier, the color-ink applier, and the colorless-liquid applier.

### Aspect 12

A printing method includes a pretreatment-liquid application step to apply a pretreatment liquid to a predetermined area on a permeable print target onto which printing is performed, a white-ink application step to apply a white ink to a predetermined area on the area to which the pretreatment liquid is applied to form a base of the white ink, a color-ink application step to apply a color ink to a predetermined area on the base of the white ink to form a color image, and a colorless-liquid application step to apply a colorless liquid including water to a predetermined area including at least a part of a trace of ink seepage area around an image forming area. The printing method adjusts the area to which the colorless liquid is applied according to a timing of applying the colorless liquid.

In other words, a printing method includes applying a pretreatment liquid to a pretreatment area in a permeable print target to form a pretreatment layer and applying a white ink including an organic solvent to an image forming area in the pretreatment area to form a base layer of the white ink on the pretreatment layer. The organic solvent seeps into a seepage area around the image forming area to form the seepage area. The printing method further includes applying a color ink including an organic solvent to the image forming area to form a color image on the base layer of the white ink, applying a colorless liquid including water to a colorless-liquid area including at least a part of the seepage area, and changing the colorless-liquid area according to a timing of applying the colorless liquid to the colorless-liquid area in a process of applying the pretreatment liquid, the white ink, and the color ink to the permeable print target.

### Aspect 13

The printing method according to Aspect 12, further includes changing an amount of the colorless liquid applied to the colorless-liquid area according to a timing of applying the colorless liquid to the colorless-liquid area in the process of applying the pretreatment liquid, the white ink, and the color ink to the permeable print target.

### Aspect 14

In the printing method of Aspect 12 or 13, an amount of the colorless liquid applied by the colorless-liquid application step is made smaller in an area in which an amount of the white ink applied by the white-ink application step is smaller.

In other words, the printing method according to Aspect 12 or 13, further includes decreasing the amount of the colorless liquid applied to the colorless-liquid area including the seepage area around the image forming area with a decrease in an amount of the white ink applied to the image forming area.

### Aspect 15

The printing method of any one of Aspects 12 or 14 further includes a heating step to perform heating after an image is formed.

In other words, the printing method according to any one of Aspects 12 or 14, further includes heating the color image formed on the permeable print target.

### Aspect 16

The printing method according to any one of Aspects 12 or 15, further includes forming a gap area to which nothing but seepage of the organic solvent seeping into the seepage area is applied between the image forming area and the colorless-liquid area in the seepage area when applying the colorless liquid to the seepage area.

### Aspect 17

The printing method according to any one of Aspects 12 or 15, further includes gradually reducing an amount of the colorless liquid, applied to the seepage area, toward the image forming area to form a sloped area in the seepage area around the image forming area.

### Aspect 18

The printing method according to any one of Aspects 12 or 15, further includes gradually increasing an amount of the pretreatment liquid, which is applied to the pretreatment area including an extended area outside the image forming area, toward the image forming area, and gradually reducing an amount of the colorless liquid applied to the extended area toward the image forming area.

As described above, according to one aspect of the present disclosure, a printing apparatus can be provided that removes a trace of ink seepage remaining after the DTG printing and has high productivity.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A printing apparatus comprising:
a pretreatment-liquid applier to apply a pretreatment liquid to a pretreatment area in a permeable print target to form a pretreatment layer;
a white-ink applier to apply a white ink including an organic solvent to an image forming area in the pretreatment area to form a base layer of the white ink on the pretreatment layer, the organic solvent seeping into a seepage area around the image forming area to form the seepage area;
a color-ink applier to apply a color ink including an organic solvent to the image forming area to form a color image on the base layer of the white ink;
a colorless-liquid applier to apply a colorless liquid including water to a colorless-liquid area including at least a part of the seepage area; and
circuitry configured to change the colorless-liquid area according to a timing of applying the colorless liquid to the colorless-liquid area in a process of applying the pretreatment liquid, the white ink, and the color ink to the permeable print target.

2. The printing apparatus according to claim 1,
wherein the circuitry is further configured to control the colorless-liquid applier to apply the colorless liquid to the colorless-liquid area including the image forming area and the seepage area after controlling the color-ink applier to apply the color ink to the image forming area.

3. The printing apparatus according to claim 1,
wherein the circuitry is further configured to control the colorless-liquid applier to apply the colorless liquid to the colorless-liquid area including the seepage area except the image forming area while controlling at least one of the white-ink applier to apply the white ink or the color-ink applier to apply the color ink to the image forming area.

4. The printing apparatus according to claim 1,
wherein the circuitry is further configured to control the colorless-liquid applier to apply the colorless liquid to the colorless-liquid area including at least a part of the seepage area and the pretreatment area before controlling the white-ink applier to apply the white ink to the image forming area.

5. The printing apparatus according to claim 1,
wherein the circuitry is further configured to change an amount of the colorless liquid applied to the colorless-liquid area according to a timing of applying the colorless liquid to the colorless-liquid area in the process of applying the pretreatment liquid, the white ink, and the color ink to the permeable print target.

6. The printing apparatus according to claim 5,
wherein the circuitry is further configured to control the colorless-liquid applier to decrease the amount of the colorless liquid applied to the colorless-liquid area including the seepage area around the image forming area with a decrease in an amount of the white ink applied to the image forming area by the white-ink applier.

7. The printing apparatus according to claim 1, further comprising a heater to heat the color image on the permeable print target.

8. The printing apparatus according to claim 1,
wherein the circuitry is further configured to control the colorless-liquid applier to form a gap area to which nothing but seepage of the organic solvent seeping into the seepage area is applied between the image forming area and the colorless-liquid area in the seepage area when the colorless-liquid applier applies the colorless liquid to the seepage area.

9. The printing apparatus according to claim 1,
wherein the circuitry is further configured to control the colorless-liquid applier to gradually reduce an amount of the colorless liquid, applied to the seepage area, toward the image forming area to form a sloped area in the seepage area around the image forming area.

10. The printing apparatus according to claim 1,
wherein the circuitry is further configured to:
control the pretreatment-liquid applier to gradually increase an amount of the pretreatment liquid, which is applied to the pretreatment area including an extended area outside the image forming area, toward the image forming area; and
control the colorless-liquid applier to gradually reduce an amount of the colorless liquid applied to the extended area toward the image forming area.

11. The printing apparatus according to claim 1, further comprising:
a first carriage mounting at least one of the pretreatment-liquid applier, the white-ink applier, the color-ink applier, or the colorless-liquid applier; and
a second carriage mounting a rest of the pretreatment-liquid applier, the white-ink applier, the color-ink applier, and the colorless-liquid applier.

12. A printing method comprising:
applying a pretreatment liquid to a pretreatment area in a permeable print target to form a pretreatment layer;
applying a white ink including an organic solvent to an image forming area in the pretreatment area to form a base layer of the white ink on the pretreatment layer, the organic solvent seeping into a seepage area around the image forming area to form the seepage area;
applying a color ink including an organic solvent to the image forming area to form a color image on the base layer of the white ink;
applying a colorless liquid including water to a colorless-liquid area including at least a part of the seepage area; and
changing the colorless-liquid area according to a timing of applying the colorless liquid to the colorless-liquid area in a process of applying the pretreatment liquid, the white ink, and the color ink to the permeable print target.

13. The printing method according to claim 12, further comprising:
changing an amount of the colorless liquid applied to the colorless-liquid area according to a timing of applying the colorless liquid to the colorless-liquid area in the process of applying the pretreatment liquid, the white ink, and the color ink to the permeable print target.

14. The printing method according to claim 13, further comprising:
decreasing the amount of the colorless liquid applied to the colorless-liquid area including the seepage area around the image forming area with a decrease in an amount of the white ink applied to the image forming area.

15. The printing method according to claim 12, further comprising:
heating the color image on the permeable print target.

16. The printing method according to claim 12, further comprising:
forming a gap area to which nothing but seepage of the organic solvent seeping into the seepage area is applied between the image forming area and the colorless-liquid area in the seepage area when applying the colorless liquid to the seepage area.

17. The printing method according to claim 12, further comprising:
gradually reducing an amount of the colorless liquid, applied to the seepage area, toward the image forming area to form a sloped area in the seepage area around the image forming area.

18. The printing method according to claim 12, further comprising:
gradually increasing an amount of the pretreatment liquid, which is applied to the pretreatment area including an extended area outside the image forming area, toward the image forming area; and
gradually reducing an amount of the colorless liquid applied to the extended area toward the image forming area.
